(19) United States
(12) Patent Application Publication
(10) Pub. No.: US 2025/0212026 A1
(43) Pub. Date: Jun. 26, 2025

(54) MODEL MONITORING METHODS, AND DEVICES

(71) Applicant: GUANGDONG OPPO MOBILE TELECOMMUNICATIONS CORP., LTD., Dongguan (CN)

(72) Inventors: Xue LIN, Dongguan (CN); Xin YOU, Dongguan (CN); Jiangsheng FAN, Dongguan (CN)

(21) Appl. No.: 19/077,270

(22) Filed: Mar. 12, 2025

Related U.S. Application Data
(63) Continuation of application No. PCT/CN2022/118719, filed on Sep. 14, 2022.

(51) Int. Cl. H04W 24/02; H04B 17/391; H04L 41/16; H04W 64/00

(52) U.S. Cl. CPC H04W 24/02; H04B 17/3913; H04L 41/16; H04W 64/006

(57) ABSTRACT

A model monitoring method includes: determining, by a first communication device, whether the first network model is valid according to the first information; where the first information is at least one of: position information of a terminal device, configuration information associated with the first network model, performance indicator information associated with the first network model, capability information of the terminal device, a timer associated with the first network model, or a number of uses of the first network model.

### CROSS-REFERENCE TO RELATED APPLICATION

This application is a Continuation Application of International Application No. PCT/CN2022/118719 filed on Sep. 14, 2022, which is incorporated herein by reference in its entirety.

### TECHNICAL FIELD

Embodiments of the present disclosure relate to the field of communications, and in particular, to a model monitoring method and a device.

### RELATED ART

In a new radio (NR) system, a network model may be introduced to improve system performance. For example, a network model is introduced to compress and decompress channel state information (CSI), so as to reduce air interface transmission overhead and improve accuracy of CSI feedback information. In another example, a network model is introduced to predict beam information in time domain/spatial domain to improve accuracy of beam selection. In yet another example, a network model is introduced to predict terminal position information to improve accuracy of the terminal position information in non-line of sight (NLOS) scenarios. However, network models are time sensitive, and how to monitor validity of network models is a problem that needs to be solved.

### SUMMARY

Embodiments of the present disclosure provide a model monitoring method and a device.

In a first aspect, a model monitoring method is provided, and the method includes: determining, by the first communication device, whether the first network model is valid according to the first information;
where the first information is at least one of: position information of a terminal device, configuration information associated with the first network model, performance indicator information associated with the first network model, capability information of a terminal device, a timer associated with the first network model, or a number of uses of the first network model.

In a second aspect, a model monitoring method is provided, and the method includes:
transmitting, by a second communication device, the first information;
where the first information is used for a first communication device to determine whether a first network model is valid;
where the first information is at least one of: position information of a terminal device, configuration information associated with the first network model, performance indicator information associated with the first network model, capability information of a terminal device, a timer associated with the first network model, or a number of uses of the first network model.

In a third aspect, a communication device is provided, which is configured to perform the method in the first aspect.

In some implementation, the communication device includes a functional module configured to perform the method in the above first aspect.

In a fourth aspect, a communication device is provided, which is configured to perform the method in the second aspect.

In some implementation, the communication device includes a functional module configured to perform the method in the above-mentioned second aspect.

In a fifth aspect, a communication device is provided, which includes a processor and a memory. The memory is configured to store a computer program, and the processor is configured to call the computer program stored in the memory and run the computer program, to cause the communication device to perform the method in the above-mentioned first aspect.

In a sixth aspect, a communication device is provided, which includes a processor and a memory. The memory is configured to store a computer program, and the processor is configured to call the computer program stored in the memory and run the computer program, to cause the communication device to perform the method in the above-mentioned second aspect.

In a seventh aspect, an apparatus is provided, which is configured to implement the method in any one of the first and second aspects described above.

In some implementation, the apparatus includes a processor, which is configured to call a computer program from a memory and run the computer program, to cause a device equipped with the apparatus to perform the method in any one of the first and second aspects described above.

In an eighth aspect, a non-transitory computer-readable storage medium is provided, which is configured to store a computer program, and the computer program causes a computer to perform the method in any one of the first and second aspects described above.

In a ninth aspect, a computer program product is provided, which includes computer program instructions, and the computer program instructions cause a computer to perform the method in any one of the first and second aspects described above.

In a tenth aspect, a computer program is provided, and the computer program, when executed on a computer, causes the computer to perform the method in any one of the first and second aspects described above.

### BRIEF DESCRIPTION OF THE DRAWINGS

FIG. 1 is a schematic diagram illustrating a communication system architecture to which the embodiments of the present disclosure are applicable.

FIG. 2 is a schematic diagram illustrating a basic structure of a neural network provided by the present disclosure.

FIG. 3 is a schematic diagram illustrating a neural network deep learning algorithm provided by the present disclosure.

FIG. 4 is a schematic diagram illustrating a convolutional neural network provided by the present disclosure.

FIG. 5 is a schematic flowchart of a model monitoring method provided in accordance with the embodiments of the present disclosure.

FIG. 6 is a schematic diagram illustrating beam spatial domain prediction provided in accordance with the embodiments of the present disclosure.

FIG. 7 is a schematic diagram illustrating beam time domain prediction provided in accordance with the embodiments of the present disclosure.

FIG. 8 is a schematic flowchart of another model monitoring method provided in accordance with the embodiments of the present disclosure.

FIG. 9 is a schematic block diagram of a communication device provided in accordance with the embodiments of the present disclosure.

FIG. 10 is a schematic block diagram of another communication device provided in accordance with the embodiments of the present disclosure.

FIG. 11 is a schematic block diagram of yet another communication device provided in accordance with the embodiments of the present disclosure.

FIG. 12 is a schematic block diagram of an apparatus provided in accordance with the embodiments of the present disclosure.

FIG. 13 is a schematic block diagram of a communication system provided in accordance with the embodiments of the present disclosure.

### DETAILED DESCRIPTION

Technical solutions in the embodiments of the present disclosure will be described below with reference to the drawings in the embodiments of the present disclosure. Obviously, the described embodiments are only part of the embodiments of the present disclosure, rather than all of the embodiments. With respect to the embodiments in this disclosure, all other embodiments acquired by ordinary technicians in the field shall fall within the scope of protection of this disclosure.

The technical solutions of the embodiments of the present disclosure can be applied to various communication systems, such as: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an NR system evolution system, an LTE-based access to unlicensed spectrum (LTE-U) system, an NR-based access to unlicensed spectrum (NR-U) system, an non-terrestrial networks (NTN) system, an universal mobile telecommunication system (UMTS), wireless local area networks (WLAN), internet of things (IoT), a wireless fidelity (WiFi), a 5th-generation (5G) system, sixth-generation communication (6G) system or other communication systems.

Generally speaking, conventional communication systems support a limited number of connections and are easy to be implemented. However, with the development of communication technology, mobile communication systems will not only support conventional communications, but will also support, for example, device to device (D2D) communication, machine to machine (M2M) communication, machine type communication (MTC), vehicle to vehicle (V2V) communication, sidelink (SL) communication, vehicle to everything (V2X) communication, or the like. The embodiments of the present disclosure can also be applied to these communication systems.

In some embodiments, the communication system in the embodiments of the present disclosure can be applied to a carrier aggregation (CA) scenario, a dual connectivity (DC) scenario, a standalone (SA) networking scenario, or a non-standalone (NSA) networking scenario.

In some embodiments, the communication system in the embodiments of the present disclosure may be applied to an unlicensed spectrum, which may also be considered as a shared spectrum. Alternatively, the communication system in the embodiments of the present disclosure may also be applied to a licensed spectrum, which may also be considered as an unshared spectrum.

In some embodiments, the communication system in the embodiments of the present disclosure may be applied to the FR1 band (corresponding to a frequency range of 410 MHz to 7.125 GHz), may also be applied to the FR2 band (corresponding to a frequency range of 24.25 GHz to 52.6 GHz), and may also be applied to new bands such as a high-frequency frequency band corresponding to a frequency range of 52.6 GHz to 71 GHz or a frequency range of 71 GHz to 114.25 GHz.

The embodiments of the present disclosure describe various embodiments in conjunction with a network device and a terminal device. The terminal device may also be referred to as a user equipment (UE), an access terminal, a user unit, a user station, a mobile station, a mobile station, a remote station, a remote terminal, a mobile device, a user terminal, a terminal, a wireless communication device, a user agent or a user device, or the like.

The terminal device may be a station (ST) in a WLAN, a cellular phone, a cordless phone, a session initiation protocol (SIP) phone, a wireless local loop (WLL) station, a personal digital assistant (PDA) device, a handheld device with wireless communication function, a computing device or other processing device connected to a wireless modem, a vehicle-mounted device, a wearable device, a terminal device in a next-generation communication system such as an NR network, or a terminal device in a future evolved public land mobile network (PLMN) network, or the like.

In the embodiments of the present disclosure, the terminal device may be deployed on land, including indoors or outdoors, handheld, wearable or vehicle-mounted; alternatively, the terminal device may be deployed on water surface (such as on ships); alternatively, the terminal device may be deployed aerially (such as on airplanes, balloons and satellites).

In the embodiments of the present disclosure, the terminal device may be a mobile phone, a pad, a computer with wireless transceiver function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in a smart city, or a wireless terminal device in a smart home, an in-vehicle communication device, a wireless communication chip/application specific integrated circuit (ASIC)/system on chip (SoC), or the like.

As an example rather than limitation, the terminal device in the embodiments of the present disclosure may also be a wearable device. The wearable device may also be called a wearable smart device, which is a general term of wearable devices developed by intelligent design on daily wear by applying wearable technology, such as glasses, gloves, watches, clothing and shoes. The wearable device is a portable device that is worn directly on the body or integrated into the user's clothing or accessories. The wearable device not only is a hardware device, but also realize powerful functions through software support, data interaction, and cloud interaction. In a broad sense, wearable smart devices include those that are fully functional, large in size, and can achieve complete or partial functions without relying on smartphones, such as smart watches or smart glasses, as well as those that only focus on a certain type of disclosure function and need to be used in conjunction with other devices such as smartphones, such as various smart bracelets and smart jewelry for monitoring vital signs.

In the embodiments of the present disclosure, the network device may be a device for communicating with a mobile device. The network device may be an access point (AP) in WLAN, a base transceiver station (BTS) in GSM or CDMA, a base station (NodeB, NB) in WCDMA, an evolutional base station (Evolutional NodeB, eNB or eNodeB) in LTE, or a relay station or access point, or a vehicle-mounted device, a wearable device, and a network device or a base station (gNB) or a transmission reception point (TRP) in an NR network, or a network device in a future evolved PLMN network or a network device in an NTN network, or the like.

As an example rather than limitation, in the embodiments of the present disclosure, the network device may have a mobile feature, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may also be a base station installed on land, water, or the like.

In the embodiments of the present disclosure, the network device may provide services for a cell, and the terminal device may communicate with the network device through transmission resources (e.g., frequency domain resources, or spectrum resources) used by the cell. The cell may be a cell corresponding to a network device (e.g., a base station). The cell may belong to a macro base station or a base station corresponding to a small cell. The small cells here may include: a metro cell, a micro cell, a pico cell, a femto cell, or the like. These small cells have the characteristics of small coverage and low transmission power, and are suitable for providing high-speed data transmission services.

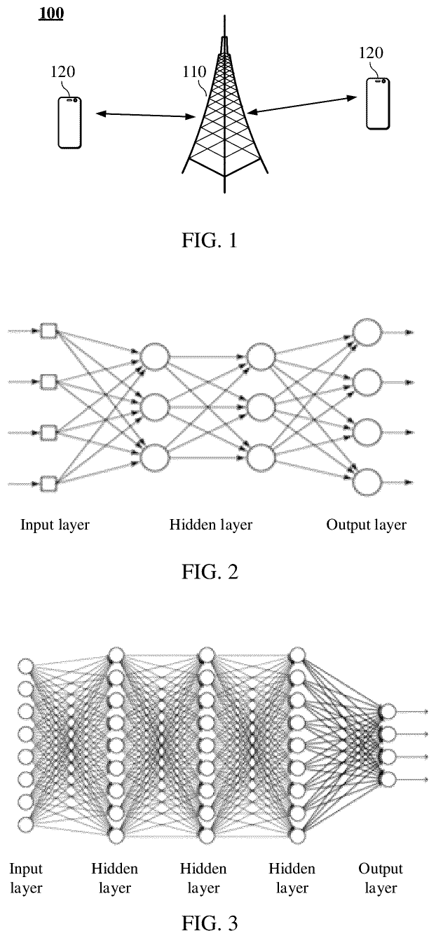

Exemplarily, a communication system 100 to which the embodiments of the present disclosure are applicable is illustrated in FIG. 1. The communication system 100 may include a network device 110, and the network device 120 may be a device for communicating with a terminal device 120 (or referred to as a communication terminal or terminal). The network device 110 may provide communication coverage for a specific geographical area, and may communicate with terminal devices located within the coverage area.

FIG. 1 exemplarily shows a network device and two terminal devices. In some embodiments, the communication system 100 may include a plurality of network devices, each of which may have a coverage area in which other number of terminal devices may be included which is not limited in the embodiments of the present disclosure.

In some embodiments, the communication system 100 may also include other network entities such as a network controller and a mobility management entity, which is not limited in the embodiments of the present disclosure.

It should be understood that a device having communication functions in the network/system in the embodiments of the present disclosure may be referred to as a communication device. Taking the communication system 100 illustrated in FIG. 1 as an example, the communication device may include a network device 110 and a terminal device 120 with communication functions. The network device 110 and the terminal device 120 may be the devices described above and will not be repeated herein. The communication devices may further include other devices in the communication system 100, such as a network controller, a mobile management entity and other network entities, which is not limited in the embodiments of the present disclosure.

It should be understood that the terms “system” and “network” are often used interchangeably herein. The term “and/or” herein is only an association relationship to describe associated objects, which indicates that there may be three kinds of relationships. For example, A and/or B may indicate three cases where: A exists alone, both A and B exist, and B exists alone. In addition, a character “/” herein generally indicates that related objects before and after the character “/” are in an “or” relationship.

It should be understood that a first communication device and a second communication device are involved herein. The first communication device may be a terminal device, such as a mobile phone, a machine facility, a customer premise equipment (CPE), an industrial equipment, vehicles, etc. The second communication device may be a peer communication device of the first communication device, such as a network device, a mobile phone, an industrial equipment, a vehicle, etc. In the embodiments of the present disclosure, the first communication device may be a terminal device, and the second communication device may be a network device (i.e., uplink communication or downlink communication); alternatively, the first communication device may be a first terminal, and the second communication device may be a second terminal (i.e., sidelink communication).

The terms used in the detailed description of the present disclosure are only for the purpose of explaining the embodiments of the present disclosure, and are not intended to limit the present disclosure. Terms “first”, “second”, “third” and “fourth”, etc., in the specification, claims, and drawings of the present disclosure are used to distinguish different objects, rather than to describe a specific order. In addition, the terms “include” and “have” and any variations thereof, are intended to cover non-exclusive inclusion.

It should be understood that the “indication” involved in the embodiments of the present disclosure may be a direct indication, may be an indirect indication, or may represent an association relationship. For example, that A indicates B may mean that A directly indicates B, for example, B may be acquired by A; or it may mean that A indicates B indirectly, for example, A indicates C, and B may be acquired through C; or it may mean that there is an association between A and B.

In the description of the embodiments of the present disclosure, the term “correspondence” may mean that there is a direct correspondence or indirect correspondence between two elements, or mean that there is an association between two elements, or mean a relationship such as indicating and being indicated, or configuring and being configured.

In the embodiments of the present disclosure, “pre-defined” or “pre-configured” may be achieved by pre-saving corresponding codes, a table, or other forms that may be used to indicate related information in a device (e.g., including the terminal device and the network device), and its specific implementation is not limited in the present disclosure. For example, “pre-defined” may refer to what is defined in a protocol.

In the embodiments of the present disclosure, the “protocol” may refer to a standard protocol in the communication field, for example, may be an evolution of an existing LTE protocol, NR protocol, Wi-Fi protocol, or protocol related to other communication systems. The type of the protocol is not limited in the present disclosure.

To facilitate understanding of the technical solutions of the embodiments of the present disclosure, the technical solutions of the present disclosure are described in detail below through some embodiments. The following related technologies may be arbitrarily combined with the technical solutions of the embodiments of the present disclosure as optional solutions, and they all belong to the protection scope of the embodiments of the present disclosure. The embodiments of the present disclosure include at least part of the following contents.

In recent years, research on artificial intelligence (AI) and its related findings have achieved good effect in many fields. Artificial intelligence has now become a new path for people to try to solve and handle problems. In numerous studies, artificial intelligence research based on neural networks is an extremely important category. The basic structure of a simple neural network includes: an input layer, a hidden layer and an output layer, as illustrated in FIG. 2. The input layer is responsible for receiving data, the hidden layer processes the data, and the final result is generated in the output layer.

With the consecutive research on the neural network, neural network deep learning algorithms have been proposed in recent years, as illustrated in FIG. 3. The multi-hidden layer neural network structure greatly improves the processing capability of the network and is widely used in pattern recognition, signal processing, optimization combination, anomaly detection, etc.

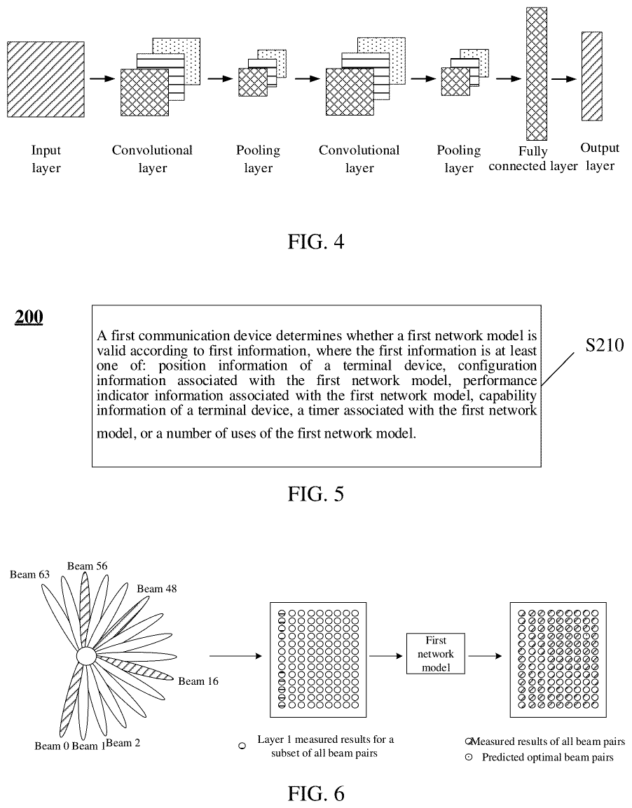

With the development of deep learning, the convolutional neural network has also been further studied. For a convolutional neural network, its basic structure includes: an input layer, a plurality of convolutional layers, a plurality of pooling layers, a fully connected layer and an output layer, as illustrated in FIG. 4. The introduction of the convolutional layers and pooling layers effectively controls the dramatic increase in network parameters, restrains the number of parameters, explores the characteristics of local structures, and improves the robustness of the algorithm.

In order to facilitate a better understanding of the embodiments of the present disclosure, an example will be described, in which an AI model related to the present disclosure is combined with the wireless communication.

The current wireless communication system provides greater flexibility than ever before, and emphasizes wide applicability to different scenarios and full utilization of limited resources. However, the basic principles of most of the current work are still based on theoretical modeling of the actual communication environment or simple parameter selection. The gains brought by this basic working mode are gradually weakened in a volatile scenario and complex communication environment, such as the conditional switching solution and problems described in the previous two sections. In light of this situation, it is currently necessary to adopt new methods and ideas, combined with conventional wireless communication theories and systems, to seek a new way, break through the performance bottleneck, and further improve the performance of wireless communication systems.

An example is AI model+CSI feedback, which uses artificial intelligence (AI)/machine learning (ML) technology to compress and decompress CSI, to reduce air interface transmission overhead, and improve the accuracy of CSI feedback information.

Another example is AI model+beam management, which uses artificial intelligence (AI)/machine learning (ML) technology to predict beam information in time domain/spatial domain, to reduce measurement overhead and latency, and improve the accuracy of beam selection.

Yet another example is AI model+positioning technology, which uses artificial intelligence (AI)/machine learning (ML) technology to predict UE position information, to improve the accuracy of UE position information in NLOS scenarios.

In order to facilitate a better understanding of the embodiments of the present disclosure, the problems to be solved by the present disclosure will be explained.

The lifecycle management of AI models includes: model generation, model deployment, model transmission, model monitoring, and model updating. For the model monitoring process, the terminal and/or network side needs to evaluate the performance of the currently running AI model and determine whether it is necessary to fall back to the conventional communication mode based on the evaluation result. However, how to monitor the network model is a problem that needs to be solved.

Based on the above problems, the present disclosure proposes a solution for model monitoring, in which a first communication device may determine whether a first network model is valid based on first information, that is, the first communication device may monitor the validity of the first network model.

In the embodiments, a model monitoring method is provided, which includes:
determining, by a first communication device, whether a first network model is valid according to first information;
where the first information is at least one of: position information of a terminal device, configuration information associated with the first network model, performance indicator information associated with the first network model, capability information of a terminal device, a timer associated with the first network model, or a number of uses of the first network model.

In some embodiments, in a case where the first information is the position information of the terminal device, the position information of the terminal device is determined based on serving cell information of the terminal device, or the position information of the terminal device is determined based on information of a transmission and reception point (TRP) accessed by the terminal device.

In some embodiments, in a case where the position information of the terminal device is determined based on the serving cell information of the terminal device, determining, by the first communication device, whether the first network model is valid according to the first information includes:
determining, by the first communication device, whether the first network model is valid according to whether a current serving cell of the terminal device belongs to a cell set associated with the first network model.

In some embodiments, determining, by the first communication device, whether the first network model is valid according to whether the current serving cell of the terminal device belongs to the cell set associated with the first network model includes:
determining, by the first communications device, that the first network model is valid, in a case where the current serving cell of the terminal device belongs to the cell set associated with the first network model; and/or
determining, by the first communications device, that the first network model is invalid, in a case where the current serving cell of the terminal device does not belong to the cell set associated with the first network model.

In some embodiments, the cell set associated with the first network model is configured or indicated by a network device, or the cell set associated with the first network model is defined by a protocol, or the cell set associated with the first network model is determined by a device that deploys the first network model.

In some embodiments, in a case where the position information of the terminal device is determined based on the serving cell information of the terminal device, determining, by the first communication device, whether the first network model is valid according to the first information includes:
determining, by the first communication device, whether the first network model is valid according to first indication information;
where the first indication information is used to indicate information of network models supported by a current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports a network model deployed on a terminal side and/or a network side.

In some embodiments, the first indication information is carried by a system broadcast message received within the current serving cell of the terminal device.

In some embodiments, in a case where the position information of the terminal device is determined based on the information of the TRP accessed by the terminal device, determining, by the first communication device, whether the first network model is valid according to the first information includes:
determining, by the first communication device, whether the first network model is valid according to whether a TRP currently accessed by the terminal device belongs to a TRP set associated with the first network model.

In some embodiments, determining, by the first communication device, whether the first network model is valid according to whether the TRP currently accessed by the terminal device belongs to the TRP set associated with the first network model, includes:
determining, by the first communications device, that the first network model is valid in a case where the TRP currently accessed by the terminal device belongs to the TRP set associated with the first network model; and/or
determining, by the first communications device, that the first network model is invalid, in a case where the TRP currently accessed by the terminal device does not belong to the TRP set associated with the first network model.

In some embodiments, the TRP set associated with the first network model is configured or indicated by a network device, or the TRP set associated with the first network model is defined by a protocol, or the TRP set associated with the first network model is determined by a device that deploys the first network model.

In some embodiments, in a case where the position information of the terminal device is determined based on the information of the TRP accessed by the terminal device, determining, by the first communication device, whether the first network model is valid according to the first information includes:
determining, by the first communication device, whether the first network model is valid according to second indication information;
where the second indication information is used to indicate information of network models supported by a TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In some embodiments, in a case where the first information is the configuration information associated with the first network model, the configuration information associated with the first network model is used to indicate communication configuration required to execute the first network model.

In some embodiments, the configuration information associated with the first network model includes at least one of communication frequency information, bandwidth information, or reference signal information.

In some embodiments, determining, by the first communication device, whether the first network model is valid according to the first information, includes:
determining, by the first communication device, that the first network model is valid, in a case where the first communication device meets the communication configuration required to execute the first network model, and/or
determining, by the first communication device, that the first network model is invalid, in a case where the first communication device does not meet the communication configuration required to execute the first network model.

In some embodiments, in a case where the first information is the performance indicator information associated with the first network model, the performance indicator information associated with the first network model is time required to achieve a preset target using the first network model, or the performance indicator information associated with the first network model is accuracy of a predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

In some embodiments, in a case where the performance indicator information associated with the first network model is the time required to achieve the preset target using the first network model, determining, by the first communication device, whether the first network model is valid according to the first information includes:
determining, by the first communication device, that the first network model is invalid, in a case where the time required to achieve the preset target using the first network model is greater than a first threshold; and/or
determining, by the first communication device, that the first network model is valid, in a case where the time required to achieve the preset target using the first network model is less than or equal to the first threshold.

In some embodiments, in a case where the performance indicator information associated with the first network model is the accuracy of the predicted result output by the first network model, determining, by the first communication device, whether the first network model is valid according to the first information includes:
determining, by the first communication device, that the first network model is valid, in a case where the predicted result output by the first network model meets an accuracy condition; and/or
determining, by the first communication device, that the first network model is invalid, in a case where the predicted result output by the first network model does not meet an accuracy condition.

In some embodiments, the accuracy condition includes at least one of the following:
a difference between the predicted result output by the first network model and a target result is less than or equal to a second threshold;
a number of predicted results having a difference with the target result less than or equal to the second threshold among predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2; or
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result, or the target result is a result obtained in a case where a function implemented with the first network model is implemented in other ways.

In some embodiments, the accuracy condition is configured by a network device, or the accuracy condition is defined by a protocol.

In some embodiments, in a case where the performance indicator information associated with the first network model is the throughput and/or bit error rate of the communication system when the first network model is used to achieve the preset target, determining, by the first communication device, whether the first network model is valid according to the first information includes:
determining, by the first communication device, that the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
determining, by the first communication device, that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
determining, by the first communication device, that the first network model is invalid, in a case where the throughput of the communication system is less than a throughput threshold when the first network model is used to achieve the preset target, and/or, in a case where the bit error rate of the communication system is greater than or equal to a bit error rate threshold when the first network model is used to achieve the preset target and a percentage of a number of terminal devices using the first network model in a current communication system to a total number of terminal devices in the current communication system is greater than or equal to a fifth threshold.

In some embodiments, in a case where the performance indicator information associated with the first network model is the quality of the radio link associated with the first network model, determining, by the first communication device, whether the first network model is valid according to the first information includes:
determining, by the first communication device, that the first network model is invalid, in a case where the quality of the radio link associated with the first network model meets a preset condition; and/or
determining, by the first communication device, that the first network model is invalid, in a case where the quality of the radio link associated with the first network model does not meet a preset condition.

In some embodiments, the preset condition includes at least one of the following: during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, where K is a positive integer and K is greater than or equal to 2; or
a spatial filter output by the first network model is used in a random access procedure, and the random access procedure is failed until a maximum number of random access channel (RACH) attempts is reached.

In some embodiments, in a case where the first information is the capability information of the terminal device, determining, by the first communication device, whether the first network model is valid according to the first information includes:
determining, by the first communication device, that the first network model is invalid, in a case where a capability of the terminal device is insufficient; and/or
determining, by the first communication device, that the first network model is valid, in a case where a capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold; or
a power variation or power rate-of-change of the terminal device is greater than or equal to a ninth threshold.

In some embodiments, in a case where the first information is the timer associated with the first network model, determining, by the first communication device, whether the first network model is valid according to the first information includes:
determining, by the first communication device, that the first network model is valid during operation of the timer associated with the first network model; and/or
determining, by the first communication device, that the first network model is invalid after the timer associated with the first network model expires.

In some embodiments, initiating timing of the timer associated with the first network model includes at least one of the following:
time when the first network model is activated, time when the first network model is successfully deployed, time when a device that deploys the first network model receives configuration information of the first network model, or one or more configured absolute time points.

In some embodiments, in a case where the first information is the number of uses of the first network model, determining, by the first communication device, whether the first network model is valid according to the first information includes:
determining, by the first communication device, that the first network model is valid, in a case where the number of uses of the first network model does not reach a preset maximum number of uses; and/or
determining, by the first communication device, that the first network model is invalid, in a case where the number of uses of the first network model reaches a preset maximum number of uses.

In some embodiments, determining, by the first communication device, whether the first network model is valid according to the first information includes:
periodically determining, by the first communication device, whether the first network model is valid according to the first information; or
determining, by the first communication device, whether the first network model is valid according to the first information in a case where a first trigger condition is met.

In some embodiments, the first trigger condition includes at least one of the following: a change in a position of the terminal device, a change in communication configuration associated with the first network model, reception of indication information for determining whether the first network model is valid, or detection of a decrease in radio link quality.

In some embodiments, in a case where the first network model is determined to be invalid, the method further includes:
performing, by the first communication device, a first step;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the method further includes:
receiving, by the first communication device, third indication information, where the third indication information is used to indicate the first communication device to perform the first step in a case where the first network model is determined to be invalid.

In some embodiments, the method further includes:
transmitting, by the first communication device, fourth indication information, where the fourth indication information is used to indicate that the first communication device has performed the first step in a case where the first network model is determined to be invalid.

In some embodiments, before determining, by the first communication device, whether the first network model is valid according to the first information, the method further includes:
receiving, by the first communication device, the first information; or
obtaining, by the first communication device, the first information.

In some embodiments, the first network model is used for channel state information (CSI) feedback, or the first network model is used for spatial filter management, or the first network model is used for positioning.

In some embodiments, the first network model is deployed on a terminal side and/or a network side.

In some embodiments, the first communication device is a terminal device, or the first communication device is a network device.

In the embodiments, a model monitoring method is provided, which includes:
transmitting, by a second communication device, first information;
where the first information is used for a first communication device to determine whether a first network model is valid;
where the first information is at least one of: position information of a terminal device, configuration information associated with the first network model, performance indicator information associated with the first network model, capability information of a terminal device, a timer associated with the first network model, or a number of uses of the first network model.

In some embodiments, in a case where the first information is the position information of the terminal device, the position information of the terminal device is determined based on serving cell information of the terminal device, or the position information of the terminal device is determined based on information of a transmission and reception point (TRP) accessed by the terminal device.

In some embodiments, in a case where the position information of the terminal device is determined based on the serving cell information of the terminal device, the first information being used for the first communication device to determine whether the first network model is valid includes that:
whether a current serving cell of the terminal device belongs to a cell set associated with the first network model is used for the first communication device to determine whether the first network model is valid.

In some embodiments, the first network model is valid, in a case where the current serving cell of the terminal device belongs to the cell set associated with the first network model; and/or, the first network model is invalid, in a case where the current serving cell of the terminal device does not belong to the cell set associated with the first network model.

In some embodiments, the cell set associated with the first network model is configured or indicated by a network device, or the cell set associated with the first network model is defined by a protocol, or the cell set associated with the first network model is determined by a device that deploys the first network model.

In some embodiments, in a case where the position information of the terminal device is determined based on the serving cell information of the terminal device, the first information being used for the first communication device to determine whether the first network model is valid includes that:
first indication information is used for the first communication device to determine whether the first network model is valid;
where the first indication information is used to indicate information of network models supported by a current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports a network model deployed on a terminal side and/or a network side.

In some embodiments, the first indication information is obtained by the first communication device from a system broadcast message received within the current serving cell of the terminal device.

In some embodiments, in a case where the position information of the terminal device is determined according to the information of the TRP accessed by the terminal device, the first information being used for the first communication device to determine whether the first network model is valid includes that:
whether a TRP currently accessed by the terminal device belongs to a TRP set associated with the first network model is used for the first communication device to determine whether the first network model is valid.

In some embodiments, the first network model is valid in a case where the TRP currently accessed by the terminal device belongs to the TRP set associated with the first network model; and/or the first network model is invalid in a case where the TRP currently accessed by the terminal device does not belong to the TRP set associated with the first network model.

In some embodiments, the TRP set associated with the first network model is configured or indicated by a network device, or the TRP set associated with the first network model is defined by a protocol, or the TRP set associated with the first network model is determined by a device that deploys the first network model.

In some embodiments, in a case where the position information of the terminal device is determined based on the information of the TRP accessed by the terminal device, the first information being used for the first communication device to determine whether the first network model is valid includes that:
second indication information is used for the first communication device to determine whether the first network model is valid;
where the second indication information is used to indicate information of network models supported by a TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In some embodiments, in a case where the first information is the configuration information associated with the first network model, the configuration information associated with the first network model is used to indicate communication configuration required to execute the first network model.

In some embodiments, the configuration information associated with the first network model includes at least one of communication frequency information, bandwidth information, or reference signal information.

In some embodiments, the first network model is valid in a case where the first communication device meets the communication configuration required to execute the first network model; and/or, the first network model is invalid in a case where the first communication device does not meet the communication configuration required to execute the first network model.

In some embodiments, in a case where the first information is the performance indicator information associated with the first network model, the performance indicator information associated with the first network model is time required to achieve a preset target using the first network model, or the performance indicator information associated with the first network model is accuracy of the predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

In some embodiments, in a case where the performance indicator information associated with the first network model is the time required to achieve the preset target using the first network model, the first information being used for the first communication device to determine whether the first network model is valid includes that:
the first network model is invalid, in a case where the time required to achieve a preset target using the first network model is greater than a first threshold; and/or
the first network model is valid, in a case where the time required to achieve a preset target using the first network model is less than or equal to a first threshold.

In some embodiments, in a case where the performance indicator information associated with the first network model is the accuracy of the predicted result output by the first network model, the first information being used for the first communication device to determine whether the first network model is valid includes that:
the first network model is valid, in a case where the predicted result output by the first network model meets an accuracy condition; and/or
the first network model is invalid, in a case where the predicted result output by the first network model does not meet an accuracy condition.

In some embodiments, the accuracy condition includes at least one of the following: a difference between the predicted result output by the first network model and a target result is less than or equal to a second threshold;
a number of predicted results having a difference with the target result less than or equal to the second threshold among the predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2; or
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result, or the target result is a result obtained in a case where a function implemented with the first network model is implemented in other ways.

In some embodiments, the accuracy condition is configured by a network device, or the accuracy condition is defined by a protocol.

In some embodiments, in a case where the performance indicator information associated with the first network model is the throughput and/or bit error rate of the communication system when the first network model is used to achieve the preset target, the first information being used for the first communication device to determine whether the first network model is valid includes that:
the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
the first network model is invalid, in a case where the throughput of the communication system is less than the throughput threshold when the first network model is used to achieve the preset target, and/or in a case where the bit error rate of the communication system is greater than or equal to the bit error rate threshold when the first network model is used to achieve the preset target and a percentage of a number of terminal devices using the first network model in a current communication system to a total number of terminal devices in the current communication system is greater than or equal to a fifth threshold.

In some embodiments, in a case where the performance indicator information associated with the first network model is the quality of the radio link associated with the first network model, the first information being used for the first communication device to determine whether the first network model is valid includes that:
the first network model is invalid, in a case where the quality of the radio link associated with the first network model meets a preset condition; and/or, the first network model is valid, in a case where the quality of the radio link associated with the first network model does not meet a preset condition.

In some embodiments, the preset condition includes at least one of the following:
during operation of a first timer, quality of a spatial filter output by the first network model monitored is monitored to be below a sixth threshold value for K consecutive times; or quality of a spatial filter output by the first network model is monitored to be below the sixth threshold value for K consecutive times within a third time period, where K is a positive integer and K is greater or equal to 2; or
a spatial filter output by the first network model is used in a random access procedure, and the random access procedure is failed until a maximum number of random access channel (RACH) attempts is reached.

In some embodiments, in a case where the first information is the capability information of the terminal device, the first information being used for the first communication device to determine whether the first network model is valid includes that:
the first network model is invalid, in a case where a capability of the terminal device is insufficient; and/or
the first network model is valid, in a case where a capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold; or
a power variation or power rate-of-change of the terminal device is greater than or equal to a ninth threshold.

In some embodiments, in a case where the first information is the timer associated with the first network model, the first information being used for the first communication device to determine whether the first network model is valid includes that:
the first network model is valid during operation of the timer associated with the first network model; and/or
the first network model is invalid after the timer associated with the first network model expires.

In some embodiments, initiating timing of the timer associated with the first network model includes at least one of the following:
time when the first network model is activated, time when the first network model is successfully deployed, time when a device that deploys the first network model receives configuration information of the first network model, or one or more configured absolute time points.

In some embodiments, in a case where the first information is the number of uses of the first network model, the first information being used for the first communication device to determine whether the first network model is valid includes that:
the first network model is valid, in a case where the number of uses of the first network model does not reach a preset maximum number of uses; and/or
the first network model is invalid, in a case where the number of uses of the first network model reaches a preset maximum number of uses.

In some embodiments, the method further includes:
transmitting, by the first communication device, third indication information, where the third indication information is used to indicate the first communication device to perform a first step in a case where the first network model is determined to be invalid;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the method further includes:
receiving, by the second communication device, fourth indication information, where the fourth indication information is used to indicate that the first communication device has performed the first step in a case where the first network model is determined to be invalid;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the first network model is used for channel state information (CSI) feedback, or the first network model is used for spatial filter management, or the first network model is used for positioning.

In some embodiments, the first network model is deployed on a terminal side and/or a network side.

In some embodiments, the first communication device is a terminal device, and the second communication device is a network device; or
the first communication device is a network device, and the second communication device is a terminal device; or
the first communication device is a terminal device, and the second communication device is another terminal device.

The technical solutions of the present disclosure will be described in detail below through some embodiments.

FIG. 5 is a schematic flowchart of a model monitoring method 200 in accordance with the embodiments of the present disclosure. As illustrated in FIG. 5, the model monitoring method 200 may include at least part of the following contents.

In S210, a first communication device determines whether a first network model is valid according to first information, where the first information is at least one of: position information of the terminal device, configuration information associated with the first network model, performance indicator information associated with the first network model, capability information of the terminal device, a timer associated with the first network model, or the number of uses of the first network model.

In the embodiments of the present disclosure, the first communication device may determine whether the first network model is valid according to the first information, that is, the first communication device may monitor the validity of the first network model.

In some embodiments, the first communication device is a terminal device, or the first communication device is a network device.

In some embodiments, the first network model is deployed on the terminal side and/or the network side.

In an example, the terminal device determines whether the first network model deployed on the terminal side is valid according to the first information.

In another example, the terminal device determines whether the first network model deployed on the network side is valid according to the first information.

In yet another example, the network device determines whether the first network model deployed on the network side is valid according to the first information.

In still yet another example, the network device determines whether the first network model deployed on the terminal side is valid according to the first information.

In some embodiments, the first network model is used for CSI feedback. In some implementation, the CSI may be compressed and decompressed according to the first network model to reduce air interface transmission overhead and improve the accuracy of CSI feedback information.

In some embodiments, the first network model is used for spatial filter management. In some implementation, the spatial filter information may be predicted in the time domain/spatial domain according to the first network model, which brings a smaller measurement overhead and a smaller delay, thereby improving the accuracy of spatial filter selection.

In some embodiments, the first network model is used for positioning. In some implementation, the position information of the terminal device may be predicted based on the first network model to improve the accuracy of the position information of the terminal device in the NLOS scenario.

In the embodiments of the present disclosure, a spatial filter may also be referred to as a beam, a spatial relation, a spatial setting, a spatial domain filter, or a reference signal.

It should be noted that the first network model described in the embodiments of the present disclosure may also be used to implement other functions, which is not limited in the present disclosure.

In the embodiments of the present disclosure, the model structure and model parameters of the first network model are not limited.

In some embodiments, before the first communication device determines whether the first network model is valid according to the first information, the first communication device receives the first information, or the first communication device obtains the first information.

As an example, the first communication device receives the first information transmitted by the second communication device. That is, the second communication device may obtain the first information through detection or other ways, and transmit the first information to the first communication device, so that the first communication device determines whether the first network model is valid according to the first information. Optionally, the first information may be carried by one of following signaling: radio resource control (RRC) signaling, downlink control information (DCI), a media access control layer control element (MAC CE), a broadcast message, a PC5 message, and sidelink control information (SCI).

As another example, the first communication device may obtain the first information through detection or other ways, and the first communication device determines whether the first network model is valid according to the first information.

In some embodiments, the first communication device is a terminal device, and the second communication device is a network device.

In some embodiments, the first communication device is a network device, and the second communication device is a terminal device.

In some embodiments, the first communication device is a terminal device, and the second communication device is another terminal device.

In an example, the first network model is deployed on the UE side, the UE side monitors the performance of the communication system and reports the monitoring result to the network, and the network determines whether the first network model is valid based on the monitoring result.

In another example, the first network model is deployed on the UE side, the UE side monitors the performance of the communication system, and determines whether the first network model is valid based on the monitoring result.

In yet another example, the first network model is deployed on the network side, the network side monitors the performance of the communication system and transmits the monitoring result to the terminal, and the terminal determines whether the first network model is valid based on the monitoring result.

In still yet another example, the first network model is deployed on the network side, the network side monitors the performance of the communication system, and determines whether the first network model is valid based on the monitoring result.

In some embodiments, in a case where the first information is the position information of the terminal device, the position information of the terminal device is determined based on serving cell information of the terminal device, or the position information of the terminal device is determined based on information of transmission reception point (TRP) accessed by the terminal device.

It should be understood that the TRP may include different service access points located within a cell, and may be understood as underlying hardware transmission devices at the cell level. UE may be located at different locations in the cell, and the UE may communicate with different TRPs.

In some embodiments, in a case where the position information of the terminal device is determined based on the serving cell information of the terminal device, the above S210 may include:
determining, by the first communication device, whether the first network model is valid according to whether a current serving cell of the terminal device belongs to a cell set associated with the first network model.

In some embodiments, in a case where the current serving cell of the terminal device belongs to the cell set associated with the first network model, the first communication device determines that the first network model is valid; and/or, in a case where the current serving cell of the terminal device does not belong to the cell set associated with the first network model, the first communication device determines that the first network model is invalid.

In some embodiments, the cell set associated with the first network model is configured or indicated by a network device, or the cell set associated with the first network model is defined by a protocol, or the cell set associated with the first network model is determined by a device that deploys the first network model.

In an example, the cell set associated with the first network model may include at least one cell, and the at least one cell may be represented by one or more cell identifiers and/or frequency information of the cell. A cell identifier includes a physical cell identifier (PCI) and/or cell global identifier (CGI) of a cell.

In some embodiments, the terminal device or the network device determines whether the identifier of the current serving cell of the terminal device is included in the cell set associated with the first network model, to determine whether the terminal device is located within a valid area of the first network model.

In some embodiments, the configuration information of the first network model carries the cell set associated with the first network model. In some implementation, when the UE performs cell selection/reselection or switching, it is determined whether the UE's current serving cell belongs to the cell set associated with the first network model. If yes, the UE continues to use the first network model; otherwise, the first network model is considered unavailable.

In some embodiments, in a case where the position information of the terminal device is determined based on the serving cell information of the terminal device, the above S210 may include:
determining, by the first communication device, whether the first network model is valid according to first indication information;
where the first indication information is used to indicate information of network models supported by the current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports a network model deployed on a terminal side and/or a network side. Optionally, the information of a network model includes a type and/or identifier of the network model.

In some embodiments, the first indication information is carried by a system broadcast message received within the current serving cell of the terminal device.

In an example, in a case where the first indication information is used to indicate information of network models supported by the current serving cell of the terminal device, if the first network model is a network model supported by the current serving cell of the terminal device that is indicated by the first indication information, the first communication device determines that the first network model is valid; and/or, if the first network model is not a network model supported by the current serving cell of the terminal device that is indicated by the first indication information, the first communication device determines that the first network model is invalid.

In an example, in a case where the first indication information is used to indicate whether the current serving cell of the terminal device supports the first network model, if the first indication information is used to indicate that the current serving cell of the terminal device supports the first network model, the first communication device determines that the first network model is valid; and/or, if the first indication information is used to indicate that the current serving cell of the terminal device does not support the first network model, the first communication device determines that the first network model is invalid.

In an example, in a case where the first indication information is used to indicate information of network models not supported by the current serving cell of the terminal device, if the first network model is not a network model not supported by the current serving cell of the terminal device that is indicated by the first indication information, the first communication device determines that the first network model is valid; and/or, if the first network model is a network model not supported by the current serving cell of the terminal device that is indicated by the first indication information, the first communication device determines that the first network model is invalid.

In an example, in a case where the first indication information is used to indicate that the current serving cell of the terminal device supports a network model deployed on the terminal side, if the first network model is the network model deployed on the terminal side, the first communication device determines that the first network model is valid; and/or, if the first network model is not the network model deployed on the terminal side, the first communication device determines that the first network model is invalid.

In an example, in a case where the first indication information is used to indicate that the current serving cell of the terminal device does not support a network model deployed on the terminal side, if the first network model is the network model deployed on the terminal side, the first communication device determines that the first network model is invalid; and/or, if the first network model is not the network model deployed on the terminal side, the first communication device determines that the first network model is valid.

In an example, in a case where the first indication information is used to indicate that the current serving cell of the terminal device supports a network model deployed on the network side, if the first network model is the network model deployed on the network side, the first communication device determines that the first network model is valid; and/or, if the first network model is not the network model deployed on the network side, the first communication device determines that the first network model is invalid.

In an example, in a case where the first indication information is used to indicate that the current serving cell of the terminal device does not support a network model deployed on the network side, if the first network model is the network model deployed on the network side, the first communication device determines that the first network model is invalid; and/or, if the first network model is not the network model deployed on the network side, the first communication device determines that the first network model is valid.

Exemplarily, information of an AI model deployed on the terminal side is Model_BM_Index=1, which indicates that the AI model is used for beam management and its model index is 1. For example, if the AI model identifier indicated by the first indication information in the system broadcast message is 1, it means that the AI model deployed on the terminal side is still applicable to the current cell. Otherwise, the AI model deployed on the terminal side is considered to be inapplicable/invalid in the current cell. As another example, if information of AI models supported by the current cell that are indicated by the first indication information in the system broadcast message includes Model_BM_Index=1, Model_BM_Index=3, and Model_BM_Index=5, and if Model_BM_Index=1 is included in the AI models supported by the current cell that are indicated by the first indication information, it is determined that the cell supports the deployed AI model.

In some embodiments, in a case where the position information of the terminal device is determined based on information of the TRP accessed by the terminal device, the above S210 includes:
determining, by the first communication device, whether the first network model is valid according to whether a TRP currently accessed by the terminal device belongs to a TRP set associated with the first network model.

In some embodiments, in a case where the TRP currently accessed by the terminal device belongs to the TRP set associated with the first network model, the first communication device determines that the first network model is valid; and/or, in a case where the TRP currently accessed by the terminal device does not belong to the TRP set associated with the first network model, the first communication device determines that the first network model is invalid.

In some embodiments, the TRP set associated with the first network model is configured or indicated by a network device, or the TRP set associated with the first network model is defined by a protocol, and the TRP set associated with the first network model is determined by a device that deploys the first network model.

In some embodiments, in a case where the position information of the terminal device is determined based on information of the TRP accessed by the terminal device, the above S210 includes:
determining, by the first communication device, whether the first network model is valid according to second indication information;
where the second indication information is used to indicate information of network models supported by a TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In an example, in a case where the second indication information is used to indicate the information of network models supported by the TRP currently accessed by the terminal device, if the first network model belongs to the network models supported by the TRP currently accessed by the terminal device that are indicated by the second indication information, the first communication device determines that the first network model is valid; and/or, if the first network model does not belong to the network models supported by the TRP currently accessed by the terminal device that are indicated by the second indication information, the first communication device determines that the first network model is invalid.

In an example, in a case where the second indication information is used to indicate whether the TRP currently accessed by the terminal device supports the first network model, if the second indication information is used to indicate that the TRP currently accessed by the terminal device supports the first network model, the first communication device determines that the first network model is valid, and/or, if the second indication information is used to indicate that the TRP currently accessed by the terminal device does not support the first network model, the first communication device determines that the first network model is invalid.

In an example, in a case where the second indication information is used to indicate the information of network models not supported by the TRP currently accessed by the terminal device, if the first network model does not belong to network models not supported by the TRP currently accessed by the terminal device that are indicated by the second indication information, the first communication device determines that the first network model is valid; and/or, if the first network model belongs to network models not supported by the TRP currently accessed by the terminal device that are indicated by the second indication information, the first communication device determines that the first network model is invalid.

In an example, in a case where the second indication information is used to indicate that the TRP currently accessed by the terminal device supports a network model deployed on the terminal side, if the first network model is the network model deployed on the terminal side, the first communication device determines that the first network model is valid; and/or, if the first network model is not the network model deployed on the terminal side, the first communication device determines that the first network model is invalid.

In an example, in a case where the second indication information is used to indicate that the TRP currently accessed by the terminal device does not support a network model deployed on the terminal side, if the first network model is the network model deployed on the terminal side, the first communication device determines that the first network model is invalid; and/or, if the first network model is not the network model deployed on the terminal side, the first communication device determines that the first network model is valid.

In an example, in a case where the second indication information is used to indicate that the TRP currently accessed by the terminal device supports a network model deployed on the network side, if the first network model is the network model deployed on the network side, the first communication device determines that the first network model is valid; and/or, if the first network model is not the network model deployed on the network side, the first communication device determines that the first network model is invalid.

In an example, in a case where the second indication information is used to indicate that the TRP currently accessed by the terminal device does not support a network model deployed on the network side, if the first network model is the network model deployed on the network side, the first communication device determines that the first network model is invalid; and/or, if the first network model is not the network model deployed on the network side, the first communication device determines that the first network model is valid.

In some embodiments, in a case where the first information is the configuration information associated with the first network model, the configuration information associated with the first network model is used to indicate communication configuration required to execute the first network model.

In some embodiments, the configuration information associated with the first network model includes but is not limited to at least one of the following: communication frequency information, bandwidth information, or reference signal information. Optionally, the communication frequency associated with the first network model includes the FR1 band and/or the FR2 band. Of course, the communication frequency associated with the first network model may also include other bands, which is not limited in the embodiments of the present disclosure.

Optionally, the bandwidth information associated with the first network model includes a bandwidth part (BWP) or other bandwidth information. Optionally, the reference signal information associated with the first network model includes but is not limited to at least one of the following: a channel state information reference signal (CSI-RS), a demodulation reference signal (DMRS), a discovery reference signal (DRS), a positioning reference signal (PRS), a phase tracking reference signal (PT-RS), a sounding reference signal (SRS), or a tracking reference signal (TRS).

In some embodiments, the configuration information associated with the first network model includes an uplink, such as a supplementary uplink (SUL), or a normal uplink (NUL).

In some embodiments, the configuration information associated with the first network model may include the complete configuration or configuration information required for communication performed by the terminal device and/or the network device.

In some embodiments, in a case where the first communication device meets the communication configuration required to execute the first network model, the first communication device determines that the first network model is valid; and/or, in a case where the first communication device does not meet the communication configuration required to execute the first network model, the first communication device determines that the first network model is invalid.

Exemplarily, the configuration information associated with the first network model includes BWP configuration (e.g., BWP ID=1). When the UE and/or the network operates on the BWP corresponding to BWP ID=1, the first network model is valid; and when the UE and/or the network operates on other BWPs other than the BWP corresponding to BWP ID=1, the first network model is invalid.

In some embodiments, in a case where the first information is the performance indicator information associated with the first network model, the performance indicator information associated with the first network model is the time required to achieve a preset target using the first network model, or the performance indicator information associated with the first network model is accuracy of the predicted result output by the first network model, or the performance indicator information associated with the first network model is throughput and/or a bit error rate of the communication system when the first network model is used to achieve a preset target, or the performance indicator information associated with the first network model is quality of a radio link associated with the first network model.

In some embodiments, in a case where the performance indicator information associated with the first network model is the time required to achieve the preset target using the first network model, the above S210 includes:
determining, by the first communication device, that the first network model is invalid, in a case where the time required to achieve the preset target using the first network model is greater than a first threshold; and/or, determining, by the first communication device, that the first network model is valid, in a case where the time required to achieve the preset target using the first network model is less than or equal to the first threshold.

It should be noted that the time required to achieve the preset target using the first network model may be the time required from inputting data into the first network model to outputting the predicted result.

In some embodiments, the first threshold is defined by a protocol, or the first threshold is configured by a network device.

In some embodiments, in a case where the performance indicator information associated with the first network model is the accuracy of the predicted result output by the first network model, the above S210 includes:
determining, by the first communication device, that the first network model is valid, in a case where the predicted result output by the first network model meets an accuracy condition; and/or, determining, by the first communication device, that the first network model is invalid, in a case where the predicted result output by the first network model does not meet an accuracy condition.

In some embodiments, the accuracy condition includes at least one of the following:
a difference between the predicted result output by the first network model and a target result is less than or equal to a second threshold;
a number of predicted results having a difference with the target result less than or equal to the second threshold among predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2 (M≥2);
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result (such as a measured result), or the target result is a result obtained in a case where a function implemented with the first network model is implemented in other ways. For example, it is assumed that the function implemented with the first network model is beam prediction, in this case, the target result may be an optimal beam determined based on a conventional beam management mode.

In some embodiments, the second threshold is defined by a protocol, or the second threshold is configured by a network device.

In some embodiments, the third threshold is defined by a protocol, or the third threshold is configured by a network device.

In some embodiments, the fourth threshold is defined by a protocol, or the fourth threshold is configured by a network device.

In some embodiments, the value of M is defined by a protocol, or the value of M is configured by a network device.

In some embodiments, the accuracy condition is configured by the network device, or the accuracy condition is defined by a protocol.

In some embodiments, as illustrated in Table 1, the first network model outputs, at time T, a predicted result for time (T+1), a predicted result for time (T+2), and a predicted result for time (T+3), and the first network model outputs, at time (T+1), a predicted result for time (T+2) and a predicted result for time (T+3). For example, the accuracy condition is that a difference between the predicted result for time (T+1) output at time T and a measured result for time (T+1) is less than or equal to the second threshold. In another example, the accuracy condition is that a difference between the predicted result for time (T+2) output at time T and the predicted result for time (T+2) output at time (T+1) is less than or equal to the fourth threshold.

Optionally, M is assumed to be 3, i.e., M=3, as illustrated in Table 1, the predicted results output by the first network model for M consecutive times may be: the predicted result for time (T+1), the predicted result for time (T+2), and the predicted result for time (T+3) that are output by the first network model at time T.

Optionally, M is assumed to be 2, i.e., M=2, as illustrated in Table 1, the predicted results output by the first network model for M consecutive times may be: the predicted result for time (T+1) and the predicted result for time (T+2) that are output by the first network model at time T, or the predicted result for time (T+2) and the predicted result for time (T+3) output by the first network model at time T, or the predicted result for time (T+2) and the predicted result for time (T+3) that are output by the first network model at time (T+1).

TABLE 1

| | |
|---|---|
| Time | Predicted result |

| | | | |
|---|---|---|---|
| T | T + 1 | T + 2 | T + 3 |
| T + 1 | Measured | T + 2 | T + 3 |
| T + 2 | | Measured | |

In an example, as illustrated in FIG. 6, the first network model is use or spatial beam prediction. The UE measures the quality of beams in set #1, and uses the first network model to predict the quality of beams in set #2. The UE measures the quality of beams in set #1 as well as the quality of all or parts of the beams in set #2, uses the first network model to obtain the quality of beams in set #2, compares the predicted results with the measured results, and evaluates the accuracy of the prediction performance of the first network model.

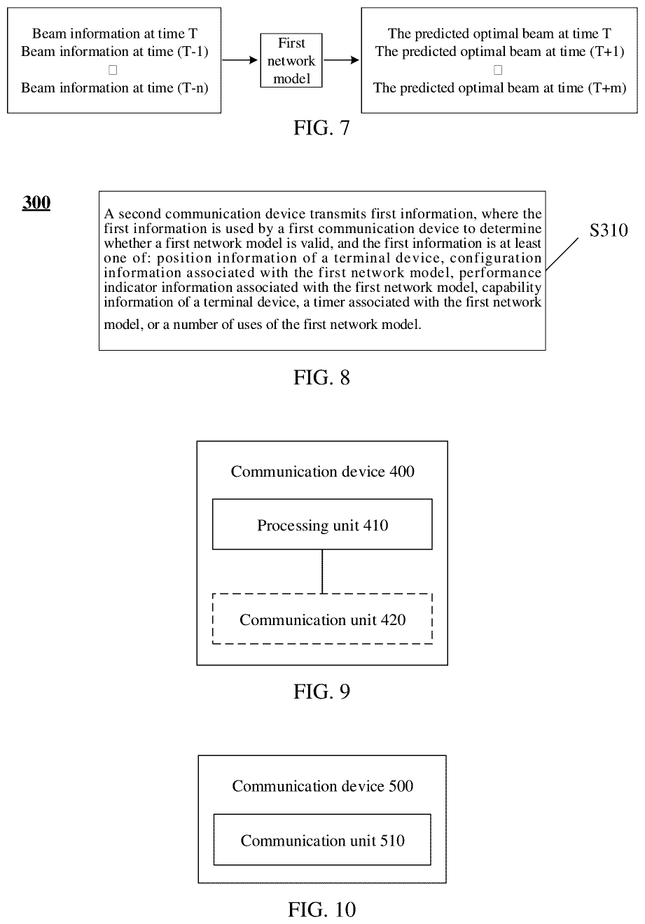

In an example, as illustrated in FIG. 7, the first network model is used for time domain beam prediction. The UE uses the first network model to predict the beam information in the future time domain according to the current and historical beam information, such as the example illustrated in Table 1.

In an example, the first network model is used for positioning accuracy enhancement. The UE may compare the position information obtained based on actual measurements and algorithms with the position information predicted with the first network model. If the difference exceeds a certain threshold value, it may be considered that the first network model is no longer valid/applicable.

In some embodiments, in a case where the performance indicator information associated with the first network model is the throughput and/or bit error rate of the communication system when the first network model is used to achieve the preset target, the above S210 includes:
determining, by the first communication device, that the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
determining, by the first communication device, that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
determining, by the first communication device, that the first network model is invalid, in a case where the throughput of the communication system is less than a throughput threshold when the first network model is used to achieve a preset target, and/or in a case where the bit error rate of the communication system is greater than or equal to a bit error rate threshold when the first network model is used to achieve the preset target, and a percentage of a number of terminal devices using the first network model in a current communication system to a total number of terminal devices in the current communication system that is greater than or equal to a fifth threshold.

In some embodiments, the fifth threshold is defined by a protocol, or the fifth threshold is configured by a network device. For example, the fifth threshold is 50%.

In some embodiments, in a case where the performance indicator information associated with the first network model is the quality of the radio link associated with the first network model, the above S210 includes:
determining, by the first communication device, that the first network model is invalid, in a case where the quality of the radio link associated with the first network model meets a preset condition; and/or
determining, by the first communication device, that the first network model is invalid, in a case where the quality of the radio link associated with the first network model does not meet a preset condition.

In some embodiments, the preset condition includes at least one of the following:
during operation of a first timer, quality of a spatial filter output by the first network model is monitored to be below a sixth threshold value for K consecutive times; or quality of a spatial filter output by the first network model monitored to be below the sixth threshold value for K consecutive times within a third time period, where K is a positive integer and K is greater than or equal to 2 (K≥2); or
a spatial filter output by the first network model is used in a random access procedure, and the random access procedure is failed until a maximum number of random access channel (RACH) attempts is reached (i.e., a RACH problem is triggered).

In some embodiments, the value of K is defined by a protocol, or the value of K is configured by a network device.

In some embodiments, the first timer is defined by a protocol, or the first timer is configured by a network device.

In some embodiments, the third time period is defined by a protocol, or the third time period is configured by a network device.

In some embodiments, the preset condition is defined by a protocol, or the preset condition is configured by a network device.

In some embodiments, in a case where the first information is the capability information of the terminal device, the above S210 includes:
determining, by the first communication device, that the first network model is invalid, in a case where the capability of the terminal device is insufficient; and/or
determining, by the first communication device, that the first network model is valid, in a case where the capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold; or
a power variation or power rate-of-change of the terminal device is greater than or equal to a ninth threshold.

In some embodiments, the computing power threshold is defined by a protocol, or the computing power threshold is configured by a network device, or the computing power threshold is determined by the terminal device.

In some embodiments, the storage threshold is defined by a protocol, or the storage threshold is configured by a network device, or the storage threshold is determined by the terminal device.

In some embodiments, the seventh threshold is defined by a protocol, or the seventh threshold is configured by a network device, or the seventh threshold is determined by the terminal device.

In some embodiments, the eighth threshold is defined by a protocol, or the eighth threshold is configured by a network device, or the eighth threshold is determined by the terminal device.

In some embodiments, the ninth threshold is defined by a protocol, or the ninth threshold is configured by a network device, or the ninth threshold is determined by the terminal device.

In some embodiments, in a case where the first information is the timer associated with the first network model, the above S210 includes:
determining, by the first communication device, that the first network model is valid during operation of the timer associated with the first network model; and/or, determining, by the first communication device, that the first network model is invalid after the timer associated with the first network model expires.

In some embodiments, initiating timing of the timer associated with the first network model includes but is not limited to at least one of the following:
the time when the first network model is activated, the time when the first network model is successfully deployed, the time when a device that deploys the first network model receives the configuration information of the first network model, or one or more configured absolute time points.

For example, the absolute time may be the universal time coordinated (UTC) time.

In some embodiments, the timer associated with the first network model is defined by a protocol, or the timer associated with the first network model is configured by a network device.

In some embodiments, the timer associated with the first network model may be obtained from the configuration information of the first network model.

In some embodiments, in a case where the first information is the number of uses of the first network model, the above S210 includes:
determining, by the first communication device, that the first network model is valid, in a case where the number of uses of the first network model does not reach a preset maximum number of times; and/or
determining, by the first communication device, that the first network model is invalid, in a case where the number of uses of the first network model reaches a preset maximum number of times.

In some embodiments, the preset maximum number of use is defined by a protocol, or the preset maximum number of uses is configured by a network device. For example, the preset maximum number of uses is 5, 8, 10, 50, etc., which is not limited in the embodiments of the present disclosure.

In some embodiments, the first communication device periodically determines whether the first network model is valid according to the first information. Optionally, the period information is defined by a protocol, or the period information is configured by a network device, or the period information may be predefined.

In some embodiments, the first communication device determines whether the first network model is valid according to the first information in a case where a first trigger condition is met.

In some embodiments, the first trigger condition includes but is not limited to at least one of the following:
a change in a position of the terminal device, a change in the communication configuration associated with the first network model, reception of indication information for determining whether the first network model is valid, or detection of a decrease in radio link quality.

In an example, detection of a decrease in radio link quality includes: detecting that a beam failure (BF) has occurred, and/or detecting that a radio link failure (RLF) has occurred.

In some embodiments, in a case where the first network model is determined to be invalid, the first communication device performs a first step.

The first step includes but is not limited to at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

It should be noted that functions implemented with the first network model may be implemented through other ways, for example, through conventional communication means, which is not limited in the embodiments of the present disclosure.

In some embodiments, the first communication device receives third indication information, and the third indication information is used to indicate the first communication device to perform the first step in a case where the first network model is determined to be invalid.

For example, the first communication device receives the third indication information transmitted by the second communication device. Optionally, the third indication information may be carried by one of the following signaling: RRC signaling, DCI, a MAC CE, a broadcast message, a PC5 message, and SCI.

In some embodiments, the first communication device transmits fourth indication information, and the fourth indication information is used to indicate that the first communication device has performed the first step in a case where the first network model is determined to be invalid.

For example, the first communication device transmits the fourth indication information to the second communication device. Optionally, the fourth indication information may be carried by one of the following signalling: RRC signaling, DCI, a MAC CE, a broadcast message, a PC5 message, and SCI.

Therefore, in the embodiments of the present disclosure, the first communication device may determine whether the first network model is valid according to the first information, that is, the first communication device may monitor the validity of the first network model.

Further, in a case where the first network model is determined to be invalid, the first communication device may perform at least one of the following steps: implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model. In this way, communication performance may be improved.

With reference to FIGS. 5 to 7, the embodiments of the first communication device in the present disclosure have been described in detail in the above. Embodiments of the second communication device in the present disclosure will be described below in detail with reference to FIG. 8. It should be understood that the embodiments of the second communication device corresponds to the embodiments of the first communication device, and reference may be made to the embodiments of the first communication device for similar description.

FIG. 8 is a schematic flowchart of a model monitoring method 300 in accordance with an embodiment of the present disclosure. As illustrated in FIG. 8, the model monitoring method 300 may include at least part of the following contents.

In S310, the second communication device transmits first information, where the first information is used for the first communication device to determine whether the first network model is valid, and the first information is at least one of: position information of the terminal device, configuration information associated with the first network model, performance indicator information associated with the first network model, capability information of the terminal device, a timer associated with the first network model, or the number of uses of the first network model.

Optionally, the first information is carried by one of the following signaling: RRC signaling, DCI, a MAC CE, broadcast message, PC5 message, and SCI.

In some embodiments, the first communication device is a terminal device, and the second communication device is a network device.

In some embodiments, the first communication device is a network device, and the second communication device is a terminal device.

In some embodiments, the first communication device is a terminal device, and the second communication device is another terminal device.

In some embodiments, the first network model is deployed on a terminal side and/or a network side.

In an example, the terminal device determines whether the first network model deployed on the terminal side is valid according to the first information.

In another example, the terminal device determines whether the first network model deployed on the network side is valid according to the first information.

In yet another example, the network device determines whether the first network model deployed on the network side is valid according to the first information.

In still yet another example, the network device determines whether the first network model deployed on the terminal side is valid according to the first information.

In some embodiments, the first network model is used for CSI feedback. In some implementation, the CSI may be compressed and decompressed based on the first network model to reduce air interface transmission overhead and improve the accuracy of CSI feedback information.

In some embodiments, the first network model is used for spatial filter management. In some implementation, the spatial filter information may be predicted in time domain/spatial domain based on the first network model, which brings a smaller measurement overhead and a smaller delay, thereby improving the accuracy of spatial filter selection.

In some embodiments, the first network model is used for positioning. In some implementation, the position information of the terminal device may be predicted based on the first network model to improve the accuracy of the position information of the terminal device in the NLOS scenario.

In the embodiments of the present disclosure, a spatial filter may also be referred to as a beam, a spatial relation, a spatial setting, a spatial domain filter, or a reference signal.

It should be noted that the first network model described in the embodiments of the present disclosure may also be used to implement other functions, which is not limited in the present disclosure.

In the embodiments of the present disclosure, the model structure and model parameters of the first network model are not limited.

In an example, the first network model is deployed on the UE side, the UE side monitors the performance of the communication system and reports the monitoring result to the network, and the network determines whether the first network model is valid based on the monitoring result.

In another example, the first network model is deployed on the UE side, the UE side monitors the performance of the communication system, and determines whether the first network model is valid based on the monitoring result.

In yet another example, the first network model is deployed on the network side, the network side monitors the performance of the communication system and transmits the monitoring result to the terminal, and the terminal determines whether the first network model is valid based on the monitoring result.

In still yet another example, the first network model is deployed on the network side, the network side monitors the performance of the communication system, and determines whether the first network model is valid based on the monitoring result.

In some embodiments, in a case where the first information is the position information of the terminal device, the position information of the terminal device is determined based on the serving cell information of the terminal device, or the position information of the terminal device is determined based on the information of the TRP accessed by the terminal device.

It should be understood that the TRP may include different service access points located within a cell, and may be understood as underlying hardware transmission devices at the cell level. UE may be located at different locations in the cell, and the UE may communicate with different TRPs.

In some embodiments, in a case where the position information of the terminal device is determined based on the serving cell information of the terminal device, the first communication device using the first information being used for the first communication device to determine whether the first network model is valid includes that:
whether a current serving cell of the terminal device belongs to a cell set associated with the first network model is used for the first communication device to determine whether the first network model is valid.

In some embodiments, in a case where the current serving cell of the terminal device belongs to the cell set associated with the first network model, the first network model is valid; and/or, in a case where the current serving cell of the terminal device does not belong to the cell set associated with the first network model, the first network model is invalid.

In some embodiments, the cell set associated with the first network model is configured or indicated by a network device, or the cell set associated with the first network model is defined by a protocol, or the cell set associated with the first network model is determined by a device that deploys the first network model.

In some embodiments, in a case where the position information of the terminal device is determined based on the serving cell information of the terminal device, the first information being used for the first communication device to determine whether the first network model is valid includes that:
the first indication information is used for the first communication device to determine whether the first network model is valid;
where the first indication information is used to indicate information of network models supported by a current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports a network model deployed on a terminal side and/or a network side.

In some embodiments, the first indication information is obtained by the first communication device from a system broadcast message received in the current serving cell of the terminal device.

In some embodiments, in a case where the position information of the terminal device is determined based on the information of the TRP accessed by the terminal device, the first information being used for the first communication device to determine whether the first network model is valid includes that:
whether a TRP currently accessed by the terminal device belongs to a TRP set associated with the first network model is used for the first communication device to determine whether the first network model is valid.

In some embodiments, the first network model is valid in a case where the TRP currently accessed by the terminal device belongs to the TRP set associated with the first network model; and/or the first network model is invalid in a case where the TRP currently accessed by the terminal device does not belong to the TRP set associated with the first network model.

In some embodiments, the TRP set associated with the first network model is configured or indicated by a network device, or the TRP set associated with the first network model is defined by a protocol, or the TRP set associated with the first network model is determined by a device that deploys the first network model.

In some embodiments, in a case where the position information of the terminal device is determined based on the information of the TRP accessed by the terminal device, the first information being used for the first communication device to determine whether the first network model is valid includes that:
second indication information is used for the first communication device to determine whether the first network model is valid;
where the second indication information is used to indicate information of network models supported by the TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In some embodiments, in a case where the first information is the configuration information associated with the first network model, the configuration information associated with the first network model is used to indicate communication configuration required to execute the first network model.

In some embodiments, the configuration information associated with the first network model includes at least one of communication frequency information, bandwidth information, or reference signal information.

In some embodiments, in a case where the first communication device meets the communication configuration required to execute the first network model, the first network model is valid; and/or, in a case where the first communication device does not meet the communication configuration required to execute the first network model, the first network model is invalid.

In some embodiments, in a case where the first information is the performance indicator information associated with the first network model, the performance indicator information associated with the first network model is the time required to achieve a preset target using the first network model, or the performance indicator information associated with the first network model is accuracy of a predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

In some embodiments, in a case where the performance indicator information associated with the first network model is the time required to achieve a preset target using the first network model, the first information being used for the first communication device to determine whether the first network model is valid includes that:
the first network model is invalid, in a case where the time required to achieve the preset target using the first network model is greater than a first threshold; and/or, the first network model is valid, in a case where the time required to achieve the preset target using the first network model is less than or equal to a first threshold.

In some embodiments, in a case where the performance indicator information associated with the first network model is the accuracy of the predicted result output by the first network model, the first information being used for the first communication device to determine whether the first network model is valid includes that:
the first network model is valid, in a case where the predicted result output by the first network model meets an accuracy condition; and/or, the first network model being invalid, in a case where the predicted result output by the first network model does not meet an accuracy condition.

In some embodiments, the accuracy condition includes at least one of the following:
a difference between the predicted result output by the first network model and a target result is less than or equal to a second threshold;
a number of predicted results having a difference with the target result less than or equal to the second threshold among the predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2 (M≥2); or
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result, or the target result is a result obtained in a case where a function implemented with the first network model is implemented in other ways.

In some embodiments, the accuracy condition is configured by a network device, or the accuracy condition is defined by a protocol.

In some embodiments, in a case where the performance indicator information associated with the first network model is the throughput and/or bit error rate of the communication system when the first network model is used to achieve a preset target, the first information being used for the first communication device to determine whether the first network model is valid includes that:
the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
the first network model is invalid, in a case where the throughput of the communication system is less than the throughput threshold when the first network model is used to achieve the preset target, and/or in a case where the bit error rate of the communication system is greater than or equal to the bit error rate threshold when the first network model is used to achieve the preset target, and a percentage of a number of terminal devices using the first network model in a current communication system to a total number of terminal devices in the current communication system is greater than or equal to a fifth threshold.

In some embodiments, in a case where the performance indicator information associated with the first network model is the quality of the radio link associated with the first network model, the first information being used for the first communication device to determine whether the first network model is valid includes that:
the first network model is invalid, in a case where the quality of the radio link associated with the first network model meets a preset condition; and/or, the first network model is valid, in a case where the quality of the radio link associated with the first network model does not meet the preset condition.

In some embodiments, the preset condition includes at least one of the following:
during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, where K is a positive integer and K is greater or equal to (K≥2); or
a spatial filter output by the first network model is used in a random access procedure, and the random access procedure is failed until the maximum number of random access channel (RACH) attempts is reached.

In some embodiments, in a case where the first information is the capability information of the terminal device, the first information being used for the first communication device to determine whether the first network model is valid includes that:
the first network model is invalid, in a case where the capability of the terminal device is insufficient; and/or
the first network model is valid, in a case where the capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold; or
a power variation or power rate-of-change of the terminal device is greater than or equal to a ninth threshold.

In some embodiments, in a case where the first information is a timer associated with the first network model, the first information being used for the first communication device to determine whether the first network model is valid includes that:
the first network model is valid during operation of the timer associated with the first network model; and/or, the first network model is invalid after the timer associated with the first network model expires.

In some embodiments, initiating timing of the timer associated with the first network model includes at least one of the following:
the time when the first network model is activated, the time when the first network model is successfully deployed, the time when a device that deploys the first network model receives the configuration information of the first network model, or one or more configured absolute time points.

In some embodiments, in a case where the first information is the number of uses of the first network model, the first information being used for the first communication device to determine whether the first network model is valid includes that:
the first network model is valid, in a case where the number of uses of the first network model does not reach a preset maximum number of uses; and/or, the first network model is invalid, in a case where the number of uses of the first network model reaches a preset maximum number of uses.

In some embodiments, the first communication device transmits third indication information, and the third indication information is used to indicate the first communication device to perform a first step in a case where the first network model is determined invalid;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the second communication device receives fourth indication information, and the fourth indication information is used to indicate that the first communication device has performed the first step in a case where the first network model is determined to be invalid;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

Therefore, in the embodiments of the present disclosure, the first communication device may determine whether the first network model is valid according to the first information, that is, the first communication device may monitor the validity of the first network model.

Further, in a case where the first network model is determined to be invalid, the first communication device may perform at least one of the following steps: implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model. In this way, communication performance may be improved.

With reference to FIGS. 5 to 8, the method embodiments of the present disclosure have been described in detail in the above. Apparatus embodiments of the present disclosure will be described below in detail with reference to FIGS. 9 to 13. It should be understood that the apparatus embodiments and the method embodiments correspond to each other, reference may be made to the method embodiments for the similar description.

FIG. 9 shows a schematic block diagram of a communication device 400 in accordance with the embodiments of the present disclosure. The communication device 400 is a first communication device. As illustrated in FIG. 9, the communication device 400 includes:
a processing unit 410, configured to determine whether the first network model is valid according to the first information;
where the first information is at least one of: position information of the terminal device, configuration information associated with the first network model, performance indicator information associated with the first network model, capability information of the terminal device, a timer associated with the first network model, or a number of uses of the first network model.

In some embodiments, in a case where the first information is the position information of the terminal device, the position information of the terminal device is determined based on serving cell information of the terminal device, or the position information of the terminal device is determined based on information of a transmission and reception point (TRP) accessed by the terminal device.

In some embodiments, in a case where the position information of the terminal device is
determined based on the serving cell information of the terminal device, the processing unit 410 is configured to:
determine whether the first network model is valid according to whether a current serving cell of the terminal device belongs to a cell set associated with the first network model.

In some embodiments, the processing unit 410 is configured to:
determine that the first network model is valid, in a case where the current serving cell of the terminal device belongs to the cell set associated with the first network model; and/or
determine that the first network model is invalid, in a case where the current serving cell of the terminal device does not belong to the cell set associated with the first network model.

In some embodiments, the cell set associated with the first network model is configured or indicated by a network device, or the cell set associated with the first network model is defined by a protocol, and the cell set associated with the first network model is determined by a device that deploys the first network model.

In some embodiments, in a case where the position information of the terminal device is determined based on the serving cell information of the terminal device, the processing unit 410 is configured to:
determine whether the first network model is valid according to first indication information;
where the first indication information is used to indicate information of network models supported by a current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports a network model deployed on a terminal side and/or a network side.

In some embodiments, the first indication information is carried by a system broadcast message in the current serving cell of the terminal device.

In some embodiments, in a case where the position information of the terminal device is determined based on the information of the TRP accessed by the terminal device, the processing unit 410 is configured to:
determine whether the first network model is valid according to whether the TRP currently accessed by the terminal device belongs to the TRP set associated with the first network model.

In some embodiments, the processing unit 410 is configured to:
determine that the first network model is valid, in a case where the TRP currently accessed by the terminal device belongs to the TRP set associated with the first network model; and/or
determine that the first network model is invalid, in a case where the TRP currently accessed by the terminal device does not belong to a TRP set associated with the first network model.

In some embodiments, the TRP set associated with the first network model is configured or indicated by a network device, or the TRP set associated with the first network model is defined by a protocol, or the TRP set associated with the first network model is determined by a device that deploys the first network model.

In some embodiments, in a case where the position information of the terminal device is determined based on the information of the TRP accessed by the terminal device, the processing unit 410 is configured to:
determine whether the first network model is valid according to second indication information;
where the second indication information is used to indicate information of network models supported by a TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In some embodiments, in a case where the first information is the configuration information associated with the first network model, the configuration information associated with the first network model is used to indicate communication configuration required to execute the first network model.

In some embodiments, the configuration information associated with the first network model includes at least one of communication frequency information, bandwidth information, or reference signal information.

In some embodiments, the processing unit 410 is configured to:
determine that the first network model is valid, in a case where the first communication device meets the communication configuration required to execute the first network model, and/or, determine that the first network model is invalid, in a case where the first communication device does not meet the communication configuration required to execute the first network model.

In some embodiments, in a case where the first information is the performance indicator information associated with the first network model, the performance indicator information associated with the first network model is the time required to achieve a preset target using the first network model, or the performance indicator information associated with the first network model is accuracy of the predicted result output by the first network model, or the performance indicator information associated with the first network model is throughput and/or a bit error rate of the communication system when the first network model is used to achieve the preset target, or the performance indicator information associated with the first network model is quality of a radio link associated with the first network model.

In some embodiments, in a case where the performance indicator information associated with the first network model is the time required to achieve a preset target using the first network model, the processing unit 410 is configured to:
determine that the first network model is invalid, in a case where the time required to achieve the preset target using the first network model is greater than a first threshold; and/or
determine that the first network model is valid, in a case where the time required to achieve the preset target by using the first network model is less than or equal to the first threshold.

In some embodiments, in a case where the performance indicator information associated with the first network model is the accuracy of the predicted result output by the first network model, the processing unit 410 is configured to:
in a case where the predicted result output by the first network model meets an accuracy condition, determine that the first network model is valid; and/or
determine that the first network model is invalid, in a case where the predicted result output by the first network model does not meet an accuracy condition.

In some embodiments, the accuracy condition includes at least one of the following:
a difference between the predicted result output by the first network model and a target result is less than or equal to a second threshold;
a number of predicted results having a difference with the target result less than or equal to the second threshold among predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2 (M≥2);
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result, or the target result is a result obtained in a case where a function implemented with the first network model is implemented in other ways.

In some embodiments, the accuracy condition is configured by a network device, or the accuracy condition is defined by a protocol.

In some embodiments, in a case where the performance indicator information associated with the first network model is the throughput and/or bit error rate of the communication system when the first network model is used to achieve a preset target, the processing unit 410 is configured to:
determine that the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
determine that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
determine that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target, and a percentage of a number of terminal devices using the first network model in a current communication system to a total number of terminal devices in the current communication system is greater than or equal to a fifth threshold.

In some embodiments, in a case where the performance indicator information associated with the first network model is the quality of the radio link associated with the first network model, the processing unit 410 is configured to:
determine that the first network model is invalid, in a case where the quality of the radio link associated with the first network model meets a preset condition; and/or
determine that the first network model is invalid, in a case where the quality of the radio link associated with the first network model does not meet a preset condition.

In some embodiments, the preset condition includes at least one of the following:
during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, where K is a positive integer and K is greater than or equal to 2 (K≥2); or
a spatial filter output by the first network model is used in a random access procedure, and the random access procedure is failed until the maximum number of random access channel (RACH) attempts is reached.

In some embodiments, in a case where the first information is the capability information of the terminal device, the processing unit 410 is configured to:
determine that the first network model is invalid, in a case where the capability of the terminal device is insufficient; and/or
determine that the first network model is valid in a case where the capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold;
a power variation or power rate-of-change of the terminal device is greater than or equal to a ninth threshold.

In some embodiments, in a case where the first information is the timer associated with the first network model, the processing unit 410 is configured to:
determine that the first network model is valid during operation of the timer associated with the first network model; and/or
determine that the first network model is invalid after the timer associated with the first network model expires.

In some embodiments, initiating timing of the timer associated with the first network model includes at least one of the following:
the time when the first network model is activated, the time when the first network model is successfully deployed, the time when a device that deploys the first network model receives the configuration information of the first network model, or one or more configured absolute time points.

In some embodiments, in a case where the first information is the number of uses of the first network model, the processing unit 410 is configured to:
determine that the first network model is valid, in a case where the number of uses of the first network model does not reach a preset maximum number of uses; and/or
determine that the first network model is invalid, in a case where the number of uses of the first network model reaches a preset maximum number of uses.

In some embodiments, the processing unit 410 is configured to:
periodically determine whether the first network model is valid according to the first information; or
determine whether the first network model is valid according to the first information, in a case where the first trigger condition is met.

In some embodiments, the first trigger condition includes at least one of the following:
a change in a position of the terminal device, a change in the communication configuration associated with the first network model, reception of indication information for determining whether the first network model is valid, or detection of a decrease in radio link quality.

In some embodiments, in a case where the first network model is determined to be invalid, the processing unit 410 is further configured to perform a first step;
where the first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the communication device 400 further includes a communication unit 420. The communication unit 420 is configured to receive third indication information, and the third indication information is used to indicate the first communication device to perform the first step in a case where the first network model is determined to be invalid.

In some embodiments, the communication device 400 further includes a communication unit 420. The communication unit 420 is configured to transmit fourth indication information, and the fourth indication information is used to indicate that the first communication device has performed the first step in a case where the first network model is determined to be invalid.

In some embodiments, the communication device 400 further includes a communication unit 420. The communication unit 420 is configured to receive the first information or obtain the first information before the first communication device determines whether the first network model is valid according to the first information.

In some embodiments, the first network model is used for channel state information (CSI) feedback, or the first network model is used for spatial filter management, or the first network model is used for positioning.

In some embodiments, the first network model is deployed on a terminal side and/or a network side.

In some embodiments, the first communication device is a terminal device, or the first communication device is a network device.

In some embodiments, a communication unit mentioned above may be a communication interface or a transceiver, or an input/output interface of a communication chip or a system on chip.

A processing unit mentioned above may be one or more processors.

It should be understood that the communication device 400 in the embodiments of the present disclosure may correspond to the first communication device in the method embodiments of the present disclosure, and the above and other operations and/or functions of each unit in the communication device 400 are respectively for implementing the corresponding processes performed by the first communication device in the method 200 illustrated in FIG. 5, which will not be repeated here for the sake of brevity.

FIG. 10 shows a schematic block diagram of a communication device 500 in accordance with the embodiments of the present disclosure. The communication device 500 is a second communication device. As illustrated in FIG. 10, the communication device 500 includes:
a communication unit 510, configured to transmit first information;
where the first information is used for the first communication device to determine whether the first network model is valid;
where the first information is at least one of: position information of the terminal device, configuration information associated with the first network model, performance indicator information associated with the first network model, capability information of the terminal device, a timer associated with the first network model, or a number of uses of the first network model.

In some embodiments, in a case where the first information is the position information of the terminal device, the position information of the terminal device is determined based on serving cell information of the terminal device, or the position information of the terminal device is determined based on information of a transmission and reception point (TRP) accessed by the terminal device.

In some embodiments, in a case where the position information of the terminal device is determined based on the serving cell information of the terminal device, the first information being used for the first communication device to determine whether the first network model is valid includes that:
whether a current serving cell of the terminal device belongs to the cell set associated with the first network model is used for the first communication device to determine whether the first network model is valid.

In some embodiments, in a case where the current serving cell of the terminal device belongs to the cell set associated with the first network model, the first network model is valid; and/or, in a case where the current serving cell of the terminal device does not belong to the cell set associated with the first network model, the first network model is invalid.

In some embodiments, the cell set associated with the first network model is configured or indicated by a network device, or the cell set associated with the first network model is defined by a protocol, and the cell set associated with the first network model is determined by a device that deploys the first network model.

In some embodiments, in a case where the position information of the terminal device is determined based on the serving cell information of the terminal device, the first information being used for the first communication device to determine whether the first network model is valid includes that:
the first indication information is used for the first communication device to determine whether the first network model is valid;
where the first indication information is used to indicate information of network models supported by a current serving cell of the terminal device, or the first indication information is used to indicate whether the current serving cell of the terminal device supports the first network model, or the first indication information is used to indicate information of network models not supported by the current serving cell of the terminal device, or the first indication information is used to indicate whether the current serving cell of the terminal device supports the network model deployed on a terminal side and/or a network side.

In some embodiments, the first indication information is obtained by the first communication device from a system broadcast message received in the current serving cell of the terminal device.

In some embodiments, in a case where the position information of the terminal device is determined based on the information of the TRP accessed by the terminal device, the first information being used for the first communication device to determine whether the first network model is valid includes that:
whether a TRP currently accessed by the terminal device belongs to the TRP set associated with the first network model is used for the first communication device to determine whether the first network model is valid.

In some embodiments, in a case where the TRP currently accessed by the terminal device belongs to the TRP set associated with the first network model, the first network model is valid; and/or in a case where the TRP currently accessed by the terminal device does not belong to the TRP set associated with the first network model, the first network model is invalid.

In some embodiments, the TRP set associated with the first network model is configured or indicated by a network device, or the TRP set associated with the first network model is defined by a protocol, and the TRP set associated with the first network model is determined by a device that deploys the first network model.

In some embodiments, in a case where the position information of the terminal device is determined based on the information of the TRP accessed by the terminal device, the first information being used for the first communication device to determine whether the first network model is valid includes that:
second indication information is used for the first communication device to determine whether the first network model is valid;
where the second indication information is used to indicate information of network models supported by the TRP currently accessed by the terminal device, or the second indication information is used to indicate whether the TRP currently accessed by the terminal device supports the first network model, or the second indication information is used to indicate information of network models not supported by the TRP currently accessed by the terminal device, or the second indication information is used to indicate whether the TRP currently accessed by the terminal device supports a network model deployed on a terminal side and/or a network side.

In some embodiments, in a case where the first information is the configuration information associated with the first network model, the configuration information associated with the first network model is used to indicate communication configuration required to execute the first network model.

In some embodiments, the configuration information associated with the first network model includes at least one of communication frequency information, bandwidth information, or reference signal information.

In some embodiments, in a case where the first communication device meets the communication configuration required to execute the first network model, the first network model is valid; and/or, in a case where the first communication device does not meet the communication configuration required to execute the first network model, the first network model is invalid.

In some embodiments, in a case where the first information is the performance indicator information associated with the first network model, the performance indicator information associated with the first network model is the time required to achieve a preset target using the first network model, or the performance indicator information associated with the first network model is accuracy of the predicted result output by the first network model, or the performance indicator information associated with the first network model is throughput and/or a bit error rate of the communication system when the first network model is used to achieve the preset target, or the performance indicator information associated with the first network model is quality of a radio link associated with the first network model.

In some embodiments, in a case where the performance indicator information associated with the first network model is the time required to achieve a preset target using the first network model, the first information being used for the first communication device to determine whether the first network model is valid includes that:
the first network model is invalid, in a case where the time required to achieve the preset target using the first network model is greater than a first threshold; and/or, the first network model is valid, in a case where the time required to achieve the preset target using the first network model is less than or equal to a first threshold.

In some embodiments, in a case where the performance indicator information associated with the first network model is the accuracy of the predicted result output by the first network model, the first information being used for the first communication device to determine whether the first network model is valid includes that:
the first network model is valid, in a case where the predicted result output by the first network model meets an accuracy condition; and/or
the first network model is invalid, in a case where the predicted result output by the first network model does not meet an accuracy condition.

In some embodiments, the accuracy condition includes at least one of the following:
a difference between the predicted result output by the first network model and a target result is less than or equal to a second threshold;
a number of predicted results having a difference with the target result less than or equal to the second threshold among the predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, where M is a positive integer and M is greater than or equal to 2 (M≥2);
a difference between two predicted results for a same time point, that come from a plurality of predicted results output by the first network model within a first time period and a plurality of predicted results output by the first network model within a second time period, respectively, is less than or equal to a fourth threshold.

In some embodiments, the target result is a real result, or the target result is a result obtained in a case where a function implemented with the first network model is implemented in other ways.

In some embodiments, the accuracy condition is configured by a network device, or the accuracy condition is defined by a protocol.

In some embodiments, in a case where the performance indicator information associated with the first network model is the throughput and/or bit error rate of the communication system when the first network model is used to achieve a preset target, the first information being used for the first communication device to determine whether the first network model is valid includes that:
the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
the first network model is invalid, in a case where the throughput of the communication system is less than the throughput threshold when the first network model is used to achieve the preset target, and/or in a case where the bit error rate of the communication system is greater than or equal to the bit error rate threshold when the first network model is used to achieve the preset target, and a percentage of a number of terminal devices using the first network model in a current communication system to a total number of terminal devices in the current communication system is greater than or equal to a fifth threshold.

In some embodiments, in a case where the performance indicator information associated with the first network model is the quality of the radio link associated with the first network model, the first information being used for the first communication device to determine whether the first network model is valid includes that:
the first network model is invalid, in a case where the quality of the radio link associated with the first network model meets a preset condition; and/or, the first network model is valid, in a case where the quality of the radio link associated with the first network model does not meet the preset condition.

In some embodiments, the preset condition includes at least one of the following:
during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, where K is a positive integer and K is greater or equal to 2 (K≥2); or
a spatial filter output by the first network model is used in a random access procedure, and the random access procedure is failed until the maximum number of random access channel (RACH) attempts is reached.

In some embodiments, in a case where the first information is the capability information of the terminal device, the first information being used for the first communication device to determine whether the first network model is valid includes that:
the first network model is invalid, in a case where the capability of the terminal device is insufficient; and/or
the first network model is valid, in a case where the capability of the terminal device is sufficient.

In some embodiments, that the capability of the terminal device is insufficient includes at least one of the following:
computing power for executing the first network model is less than or equal to a computing power threshold;
remaining computing power after executing the first network model is less than or equal to a computing power threshold;
a remaining storage space of the terminal device is less than or equal to a storage threshold;
remaining power of the terminal device is less than or equal to a power threshold;
a computing power variation or computing power rate-of-change of the terminal device is greater than or equal to a seventh threshold;
a storage space variation or storage space rate-of-change of the terminal device is greater than or equal to an eighth threshold; or
a power variation or power rate-of-change of the terminal device is greater than or equal to a ninth threshold.

In some embodiments, in a case where the first information is the timer associated with the first network model, the first information being used for the first communication device to determine whether the first network model is valid includes that:
the first network model is valid during operation of the timer associated with the first network model; and/or, the first network model is invalid after the timer associated with the first network model expires.

In some embodiments, initiating timing of the timer associated with the first network model includes at least one of the following:
the time when the first network model is activated, the time when the first network model is successfully deployed, the time when a device that deploys the first network model receives configuration information of the first network model, or one or more configured absolute time points.

In some embodiments, in a case where the first information is the number of uses of the first network model, the first information being used for the first communication device to determine whether the first network model is valid includes that:
the first network model is valid, in a case where the number of uses of the first network model does not reach a preset maximum number of uses; and/or, the first network model is invalid, in a case where the number of uses of the first network model reaches a preset maximum number of uses.

In some embodiments, the communication unit 510 is further configured to transmit third indication information, and the third indication information is used to indicate the first communication device to perform a first step in a case where the first network model is determined to be invalid.

The first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the communication unit 510 is further configured to receive fourth indication information, and the fourth indication information is used to indicate that the first communication device has performed the first step in a case where the first network model is determined to be invalid.

The first step includes at least one of the following:
implementing a function implemented with the first network model in other ways, switching from the first network model to another network model that is used for implementing a same function implemented with the first network model, deactivating the first network model, activating another network model that is used for implementing a same function implemented with the first network model, retraining the first network model, updating the first network model, releasing the first network model, or stopping using the first network model.

In some embodiments, the first network model is used for channel state information (CSI) feedback, or the first network model is used for spatial filter management, or the first network model is used for positioning.

In some embodiments, the first network model is deployed on a terminal side and/or a network side.

In some embodiments, the first communication device is a terminal device, and the second communication device is a network device; or
the first communication device is a network device, and the second communication device is a terminal device; or
the first communication device is a terminal device, and the second communication device is another terminal device.

In some embodiments, a communication unit mentioned above may be a communication interface or a transceiver, or an input/output interface of a communication chip or a system on chip. A processing unit mentioned above may be one or more processors.

It should be understood that the communication device 500 in the embodiments of the present disclosure may correspond to the second communication device in the method embodiments of the present disclosure, and the above and other operations and/or functions of each unit in the communication device 500 are respectively for implementing the corresponding processes performed by the second communication device in the method 300 illustrated in FIG. 8, which will not be repeated here for the sake of brevity.

FIG. 11 is a schematic structural diagram of a communication device 600 provided in the embodiments of the present disclosure. The communication device 600 illustrated in FIG. 11 includes a processor 610. The processor 610 may call a computer program from a memory and run the computer program, to implement the methods in the embodiments of the present disclosure.

In some embodiments, as illustrated in FIG. 11, the communication device 600 may further include a memory 620. The processor 610 may call a computer program from the memory 620 and run the computer program, to implement the methods in the embodiments of the present disclosure.

The memory 620 may be a separate device independent of the processor 610, or may be integrated into the processor 610.

In some embodiments, as illustrated in FIG. 11, the communication device 600 may further include a transceiver 630, and the processor 610 may control the transceiver 630 to communicate with other devices, for example, may transmit information or data to other devices, or receive information or data transmitted by other devices.

The transceiver 630 may include a transmitter and a receiver. The transceiver 630 may further include antenna(s), and the number of the antenna(s) may be one or more.

In some embodiments, the processor 610 may implement the functions of a processing unit in the first communication device, or the processor 610 may implement the functions of a processing unit in the second communication device, which will not be repeated herein again for the sake of brevity.

In some embodiments, the transceiver 630 may implement the functions of a communication unit in the first communication device, which will not be repeated here for the sake of brevity.

In some embodiments, the transceiver 630 may implement the functions of a communication unit in the second communication device, which will not be repeated here for the sake of brevity.

In some embodiments, the communication device 600 may be the first communication device in the embodiments of the present disclosure, and the communication device 600 may implement the corresponding processes implemented by the first communication device in each method in the embodiments of the present disclosure, which will not be repeated here for the sake of brevity.

In some embodiments, the communication device 600 may be the second communication device in the embodiments of the present disclosure, and the communication device 600 may implement the corresponding processes implemented by the second communication device in each method in the embodiments of the present disclosure, which will not be repeated here for the sake of brevity.

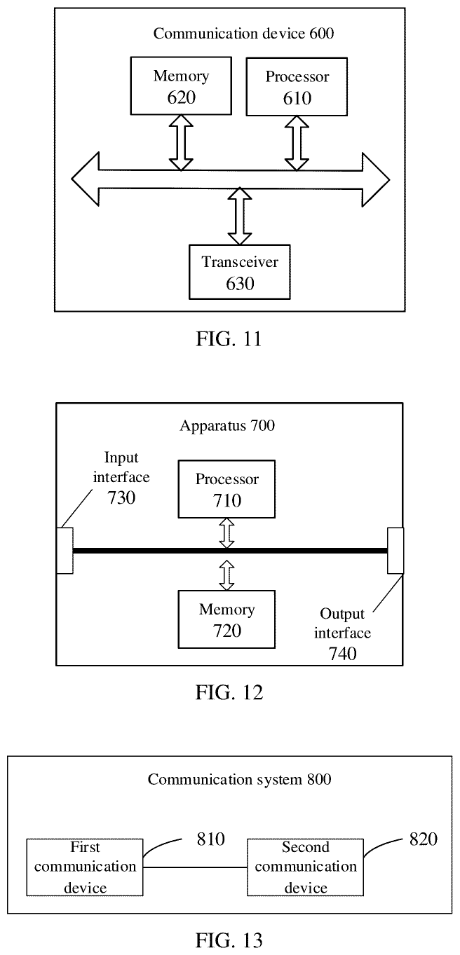

FIG. 12 is a schematic structural diagram of a device in accordance with the embodiments of the present disclosure. The apparatus 700 illustrated in FIG. 12 includes a processor 710, and the processor 710 may call a computer program from a memory and run the computer program, to implement the methods in the embodiments of the present disclosure.

In some embodiments, as illustrated in FIG. 12, the apparatus 700 may further include a memory 720. The processor 710 may call a computer program from the memory 720 and run the computer program, to implement the methods in the embodiments of the present disclosure.

The memory 720 may be a separate device independent of the processor 710, or may be integrated into the processor 710.

In some embodiments, the apparatus 700 may further include an input interface 730. The processor 710 may control the input interface 730 to communicate with other devices or chips, and for example, may acquire information or data transmitted by other devices or chips. Optionally, the processor 710 may be integrated into a chip or independent of a chip.

In some embodiments, the processor 710 may implement the functions of a processing unit in the first communication device, or the processor 710 may implement the functions of a processing unit in the second communication device, which will not be repeated here for the sake of brevity.

In some embodiments, the input interface 730 may implement the functions of a communication unit in the first communication device, or the input interface 730 may implement the functions of a communication unit in the second communication device.

In some embodiments, the apparatus 700 may further include an output interface 740. The processor 710 may control the output interface 740 to communicate with other devices or chips, and for example, may output information or data to other devices or chips. Optionally, the processor 710 may be integrated into a chip or independent of a chip.

In some embodiments, the output interface 740 may implement the functions of a communication unit in the first communication device, or the output interface 740 may implement the functions of a communication unit in the second communication device.

In some embodiments, the apparatus may be applied to the first communication device in the embodiments of the present disclosure, and the apparatus may implement the corresponding processes implemented by the first communication device in the various methods in the embodiments of the present disclosure, which will not be repeated here for the sake of brevity.

In some embodiments, the apparatus may be applied to the second communication device in the embodiments of the present disclosure, and the apparatus may implement the corresponding processes implemented by the second communication device in the various methods in the embodiments of the present disclosure, which will not be repeated here for the sake of brevity.

In some embodiments, the apparatus/device mentioned in the embodiments of the present disclosure may also be a chip. For example, it may be a system-level chip, a system chip, a chip system or a system-on-chip.

FIG. 13 is a schematic block diagram of a communication system 800 provided in the embodiments of the present disclosure. As illustrated in FIG. 13, the communication system 800 includes a first communication device 810 and a second communication device 820.

The first communication device 810 may be configured to implement the corresponding functions implemented by the first communication device in the above method, and the second communication device 820 may be configured to implement the corresponding functions implemented by the second communication device in the above method, which will not be repeated here for the sake of brevity.

It should be understood that the processor in the embodiments of the present disclosure may be an integrated circuit chip with signal processing capabilities. In the implementation process, each step of the above method embodiments can be completed by an integrated logic circuit of hardware in a processor or an instruction in software form. The above-mentioned processor can be a general-purpose processor, a digital signal processor (DSP), an application specific integrated circuit (ASIC), a field programmable gate array (FPGA) or other programmable logic devices, discrete gate or transistor logic devices, and discrete hardware components. The various methods, steps and logic diagrams disclosed in the embodiments of the present disclosure can be implemented or executed. A general purpose processor may be a microprocessor, or the processor may be any conventional processor, or the like. The steps of the method disclosed in the embodiments of the present disclosure can be directly implemented as being executed by a hardware decoding processor, or may be implemented by a combination of hardware and software modules in the decoding processor. The software module may be located in a random access memory, a flash memory, a read-only memory, a programmable read-only memory, or an electrically erasable programmable memory, a register, or other mature storage media in the art. The storage medium is located in the memory, and the processor reads the information in the memory and completes the steps of the above method in combination with its hardware.

It can be understood that the memory in the embodiments of the present disclosure may be a volatile memory or a non-volatile memory, or may include both volatile and non-volatile memories. Among them, the non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. Volatile memory can be random access memory (RAM), which acts as a external cache memory. By way of example and not limitation, many forms of RAM are available, such as static random access memory (Static RAM, SRAM), dynamic random access memory (Dynamic RAM, DRAM), synchronous dynamic random access memory (Synchronous DRAM, SDRAM), double data rate synchronous dynamic random access memory (Double Data Rate SDRAM, DDR SDRAM), enhanced synchronous dynamic random access memory (Enhanced SDRAM, ESDRAM), synchronous link dynamic random access memory (Synchlink DRAM, SLDRAM), and direct memory bus random access memory (Direct Rambus RAM, DR RAM). It should be noted that memory of the systems and methods described herein is intended to include, without being limited to, these and any other suitable types of memory.

It should be understood that the above memory is exemplary but not restrictive. For example, the memory in the embodiments of the present disclosure may also be static random access memory (static RAM, SRAM), dynamic random access memory (dynamic RAM, DRAM), synchronous dynamic random access memory (synchronous DRAM, SDRAM), double data rate synchronous dynamic random access memory (double data rate SDRAM, DDR SDRAM), enhanced synchronous dynamic random access memory (enhanced SDRAM, ESDRAM), synchronous link dynamic random access memory (synch link DRAM, SLDRAM) and direct memory bus random access memory (Direct Rambus RAM, DR RAM), etc. That is, the memory in the embodiments of the present disclosure is intended to include but is not limited to these and any other suitable types of memory.

The embodiments of the present disclosure further provide a non-transitory computer-readable storage medium configured to store a computer program.

In some embodiments, the non-transitory computer-readable storage medium may be applied to the first communication device in the embodiments of the present disclosure, and the computer program enables the computer to execute the corresponding processes implemented by the first communication device in the various methods in the embodiments of the present disclosure, which will not be repeated here for the sake of brevity.

In some embodiments, the non-transitory computer-readable storage medium may be applied to the second communication device in the embodiments of the present disclosure, and the computer program enables the computer to execute the corresponding processes implemented by the second communication device in the various methods in the embodiments of the present disclosure, which will not be repeated here for the sake of brevity.

The embodiments of the present disclosure further provide a computer program product including computer program instructions.

In some embodiments, the computer program product may be applied to the first communication device in the embodiments of the present disclosure, and the computer program instructions enable the computer to execute the corresponding processes implemented by the first communication device in the various methods in the embodiments of the present disclosure, which will not be repeated here for the sake of brevity.

In some embodiments, the computer program product may be applied to the second communication device in the embodiments of the present disclosure, and the computer program instructions enable the computer to execute the corresponding processes implemented by the second communication device in the various methods in the embodiments of the present disclosure, which will not be repeated here for the sake of brevity.

The embodiments of the present disclosure further provide a computer program.

In some embodiments, the computer program may be applied to the first communication device in the embodiments of the present disclosure. When the computer program is executed on a computer, the computer executes the corresponding processes implemented by the first communication device in the various methods in the embodiments of the present disclosure, which will not be repeated here for the sake of brevity.

In some embodiments, the computer program may be applied to the second communication device in the embodiments of the present disclosure. When the computer program is executed on a computer, the computer executes the corresponding processes implemented by the second communication device in the various methods in the embodiments of the present disclosure, which will not be repeated here for the sake of brevity.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the disclosure and design constraints of the technical solution. Professional technicians may use different methods to implement the described functions for each disclosure, but such implementation should not be considered to be beyond the scope of this disclosure.

Those skilled in the art may clearly understand that, for the convenience and brevity of description, the working processes of the systems, devices and units described above can refer to the corresponding processes in the aforementioned method embodiments and will not be repeated here.

In several embodiments provided in this disclosure, it should be understood that the disclosed systems, apparatuses, and methods may be implemented in other ways. For example, the apparatus embodiments described above are merely illustrative. For example, the division of the units is merely a logical function division. There may be other division methods in actual implementation. For example, multiple units or components may be combined or integrated into another system, or some features may be ignored or not executed. Another point is that the mutual coupling or direct coupling or communication connection shown or discussed may be an indirect coupling or communication connection through some interface, apparatus or unit, which may be electrical, mechanical or other forms.

The units described as separate components may or may not be physically separated, and the components shown as units may or may not be physical units, that is, they may be located in one place or distributed over multiple network units. Some or all of the units may be selected according to actual needs to achieve the purpose of the solution of this embodiment.

In addition, each functional unit in each embodiment of the present disclosure may be integrated into one processing unit, or each unit may exist physically separately, or two or more units may be integrated into one unit.

If the functions are implemented in the form of software functional units and sold or used as independent products, they may be stored in a non-transitory computer-readable storage medium. Based on such an understanding, the technical solution of the present disclosure may essentially be embodied in the form of a software product, or the part that contributes to the prior art, or the part of the technical solution. The computer software product is stored in a storage medium and includes a number of instructions for enabling a computer device (which can be a personal computer, a server, or a network device, etc.) to execute all or part of the steps of the method described in each embodiment of the present disclosure. The aforementioned storage media include: U disk, mobile hard disk, read-only memory (ROM), random access memory (RAM), disk or optical disk and other media that can store program code.

The above is only exemplary implementations of the present disclosure, but the protection scope of the present disclosure is not limited thereto. Any technician familiar with the technical field may easily think of changes or substitutions within the technical scope disclosed in the present disclosure, which should be covered by the protection scope of the present disclosure. Therefore, the protection scope of the present disclosure shall be based on the protection scope of the claims.

What is claimed is:

1. A model monitoring method, comprising:
determining, by a first communication device, whether a first network model is valid according to first information;
wherein the first information is at least one of: position information of a terminal device, configuration information associated with the first network model, performance indicator information associated with the first network model, capability information of a terminal device, a timer associated with the first network model, or a number of uses of the first network model.

2. The method according to claim 1, wherein in a case where the first information is the performance indicator information associated with the first network model, the performance indicator information associated with the first network model is time required to achieve a preset target using the first network model, or the performance indicator information associated with the first network model is accuracy of a predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

3. The method according to claim 2, wherein in a case where the performance indicator information associated with the first network model is the time required to achieve the preset target using the first network model, determining, by the first communication device, whether the first network model is valid according to the first information comprises:
determining, by the first communication device, that the first network model is invalid, in a case where the time required to achieve the preset target using the first network model is greater than a first threshold; and/or
determining, by the first communication device, that the first network model is valid, in a case where the time required to achieve the preset target using the first network model is less than or equal to the first threshold.

4. The method according to claim 2, wherein in a case where the performance indicator information associated with the first network model is the accuracy of the predicted result output by the first network model, determining, by the first communication device, whether the first network model is valid according to the first information comprises:
determining, by the first communication device, that the first network model is valid, in a case where the predicted result output by the first network model meets an accuracy condition; and/or
determining, by the first communication device, that the first network model is invalid, in a case where the predicted result output by the first network model does not meet an accuracy condition;
wherein the accuracy condition includes at least one of the following:
a difference between the predicted result output by the first network model and a target result is less than or equal to a second threshold;
a number of predicted results having a difference with the target result less than or equal to the second threshold among predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, wherein M is a positive integer and M is greater than or equal to 2; or
a difference between two predicted results for a same time point, that come from a plurality of predicted results output by the first network model within a first time period and a plurality of predicted results output by the first network model within a second time period, respectively, is less than or equal to a fourth threshold.

5. The method according to claim 4, wherein the target result is a real result, or the target result is a result obtained in a case where a function implemented with the first network model is implemented in other ways;
wherein the accuracy condition is configured by a network device, or the accuracy condition is defined by a protocol.

6. The method according to claim 2, wherein in a case where the performance indicator information associated with the first network model is the throughput and/or bit error rate of the communication system when the first network model is used to achieve the preset target, determining, by the first communication device, whether the first network model is valid according to the first information comprises:
determining, by the first communication device, that the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
determining, by the first communication device, that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
determining, by the first communication device, that the first network model is invalid, in a case where the throughput of the communication system is less than a throughput threshold when the first network model is used to achieve the preset target, and/or, in a case where the bit error rate of the communication system is greater than or equal to a bit error rate threshold when the first network model is used to achieve the preset target and a percentage of a number of terminal devices using the first network model in a current communication system to a total number of terminal devices in the current communication system is greater than or equal to a fifth threshold.

7. The method according to claim 2, wherein in a case where the performance indicator information associated with the first network model is the quality of the radio link associated with the first network model, determining, by the first communication device, whether the first network model is valid according to the first information comprises:
determining, by the first communication device, that the first network model is invalid, in a case where the quality of the radio link associated with the first network model meets a preset condition; and/or
determining, by the first communication device, that the first network model is invalid, in a case where the quality of the radio link associated with the first network model does not meet a preset condition;
wherein the preset condition includes at least one of the following:
during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, wherein K is a positive integer and K is greater than or equal to 2; or
a spatial filter output by the first network model is used in a random access procedure, and the random access procedure is failed until a maximum number of random access channel (RACH) attempts is reached.

8. A communication device, wherein the communication device is a first communication device, which comprises a processor and a memory, wherein the memory is configured to store a computer program, and the processor is configured to call the computer program stored in the memory and run the computer program, to cause the first communication device to perform:
determining whether a first network model is valid according to first information;
wherein the first information is at least one of: position information of a terminal device, configuration information associated with the first network model, performance indicator information associated with the first network model, capability information of a terminal device, a timer associated with the first network model, or a number of uses of the first network model.

9. The communication device according to claim 8, wherein in a case where the first information is the performance indicator information associated with the first network model, the performance indicator information associated with the first network model is time required to achieve a preset target using the first network model, or the performance indicator information associated with the first network model is accuracy of a predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

10. The communication device according to claim 9, wherein in a case where the performance indicator information associated with the first network model is the time required to achieve the preset target using the first network model, the first communication device performs:
determining that the first network model is invalid, in a case where the time required to achieve the preset target using the first network model is greater than a first threshold; and/or
determining that the first network model is valid, in a case where the time required to achieve the preset target using the first network model is less than or equal to the first threshold.

11. The communication device according to claim 9, wherein in a case where the performance indicator information associated with the first network model is the accuracy of the predicted result output by the first network model, the first communication device performs:
determining that the first network model is valid, in a case where the predicted result output by the first network model meets an accuracy condition; and/or
determining that the first network model is invalid, in a case where the predicted result output by the first network model does not meet an accuracy condition;
wherein the accuracy condition includes at least one of the following:
a difference between the predicted result output by the first network model and a target result is less than or equal to a second threshold;
a number of predicted results having a difference with the target result less than or equal to the second threshold among predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, wherein M is a positive integer and M is greater than or equal to 2; or
a difference between two predicted results for a same time point, that come from a plurality of predicted results output by the first network model within a first time period and a plurality of predicted results output by the first network model within a second time period, respectively, is less than or equal to a fourth threshold.

12. The communication device according to claim 9, wherein in a case where the performance indicator information associated with the first network model is the throughput and/or bit error rate of the communication system when the first network model is used to achieve the preset target, the first communication device performs:
determining that the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
determining that the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
determining that the first network model is invalid, in a case where the throughput of the communication system is less than a throughput threshold when the first network model is used to achieve the preset target, and/or, in a case where the bit error rate of the communication system is greater than or equal to a bit error rate threshold when the first network model is used to achieve the preset target and a percentage of a number of terminal devices using the first network model in a current communication system to a total number of terminal devices in the current communication system is greater than or equal to a fifth threshold.

13. The communication device according to claim 9, wherein in a case where the performance indicator information associated with the first network model is the quality of the radio link associated with the first network model, the first communication device performs:
determining that the first network model is invalid, in a case where the quality of the radio link associated with the first network model meets a preset condition; and/or
determining that the first network model is invalid, in a case where the quality of the radio link associated with the first network model does not meet a preset condition;
wherein the preset condition includes at least one of the following:
during operation of a first timer, quality of a spatial filter output by the first network model is monitored to be below a sixth threshold value for K consecutive times; or quality of a spatial filter output by the first network model is monitored to be below the sixth threshold value for K consecutive times within a third time period, wherein K is a positive integer and K is greater than or equal to 2; or
a spatial filter output by the first network model is used in a random access procedure, and the random access procedure is failed until a maximum number of random access channel (RACH) attempts is reached.

14. A communication device, wherein the communication device is a second communication device, which comprises a processor and a memory, wherein the memory is configured to store a computer program, and the processor is configured to call the computer program stored in the memory and run the computer program, to cause the second communication device to perform:
transmitting first information;
wherein the first information is used for a first communication device to determine whether a first network model is valid;
wherein the first information is at least one of: position information of a terminal device, configuration information associated with the first network model, performance indicator information associated with the first network model, capability information of a terminal device, a timer associated with the first network model, or a number of uses of the first network model.

15. The communication device according to claim 14, wherein in a case where the first information is the performance indicator information associated with the first network model, the performance indicator information associated with the first network model is time required to achieve a preset target using the first network model, or the performance indicator information associated with the first network model is accuracy of the predicted result output by the first network model, or the performance indicator information associated with the first network model is throughput and/or a bit error rate of a communication system when the first network model is used to achieve a preset target, or the performance indicator information associated with the first network model is quality of a radio link associated with the first network model.

16. The communication device according to claim 15, wherein in a case where the performance indicator information associated with the first network model is the time required to achieve the preset target using the first network model, the first information being used for the first communication device to determine whether the first network model is valid comprises that:
the first network model is invalid, in a case where the time required to achieve a preset target using the first network model is greater than a first threshold; and/or
the first network model is valid, in a case where the time required to achieve a preset target using the first network model is less than or equal to a first threshold.

17. The communication device according to claim 15, wherein in a case where the performance indicator information associated with the first network model is the accuracy of the predicted result output by the first network model, the first information being used for the first communication device to determine whether the first network model is valid comprises that:
the first network model is valid, in a case where the predicted result output by the first network model meets an accuracy condition; and/or
the first network model is invalid, in a case where the predicted result output by the first network model does not meet an accuracy condition;
wherein the accuracy condition includes at least one of the following:
a difference between the predicted result output by the first network model and a target result is less than or equal to a second threshold;
a number of predicted results having a difference with the target result less than or equal to the second threshold among the predicted results output by the first network model for M consecutive times is greater than or equal to a third threshold, or a proportion of predicted results, having a difference with the target result less than or equal to the second threshold, in the predicted results output by the first network model for M consecutive times is greater than or equal to a third threshold, wherein M is a positive integer and M is greater than or equal to 2; or
a difference between two predicted results for a same time point, that come from a plurality of predicted results output by the first network model within a first time period and a plurality of predicted results output by the first network model within a second time period, respectively, is less than or equal to a fourth threshold.

18. The communication device according to claim 17, wherein the target result is a real result, or the target result is a result obtained in a case where a function implemented with the first network model is implemented in other ways;
wherein the accuracy condition is configured by a network device, or the accuracy condition is defined by a protocol.

19. The communication device according to claim 15, wherein in a case where the performance indicator information associated with the first network model is the throughput and/or bit error rate of the communication system when the first network model is used to achieve the preset target, the first information being used for the first communication device to determine whether the first network model is valid comprises that:
the first network model is valid, in a case where the throughput of the communication system is greater than or equal to a throughput threshold when the first network model is used to achieve the preset target, and/or in a case where the bit error rate of the communication system is less than a bit error rate threshold when the first network model is used to achieve the preset target; and/or
the first network model is invalid, in a case where the throughput of the communication system is less than a throughput threshold when the first network model is used to achieve the preset target, and/or in a case where the bit error rate of the communication system is greater than or equal to a bit error rate threshold when the first network model is used to achieve the preset target; and/or
the first network model is invalid, in a case where the throughput of the communication system is less than the throughput threshold when the first network model is used to achieve the preset target, and/or in a case where the bit error rate of the communication system is greater than or equal to the bit error rate threshold when the first network model is used to achieve the preset target and a percentage of a number of terminal devices using the first network model in a current communication system to a total number of terminal devices in the current communication system is greater than or equal to a fifth threshold.

20. The communication device according to claim 15, wherein in a case where the performance indicator information associated with the first network model is the quality of the radio link associated with the first network model, the first information being used for the first communication device to determine whether the first network model is valid comprises that:
the first network model is invalid, in a case where the quality of the radio link associated with the first network model meets a preset condition; and/or, the first network model is valid, in a case where the quality of the radio link associated with the first network model does not meet a preset condition;
wherein the preset condition includes at least one of the following:
during operation of a first timer, quality of a spatial filter output by the first network model monitored is monitored to be below a sixth threshold value for K consecutive times; or quality of a spatial filter output by the first network model is monitored to be below the sixth threshold value for K consecutive times within a third time period, wherein K is a positive integer and K is greater or equal to 2; or
a spatial filter output by the first network model is used in a random access procedure, and the random access procedure is failed until a maximum number of random access channel (RACH) attempts is reached.
